(19) United States
(12) Patent Application Publication
(10) Pub. No.: US 2009/0076951 A1
(43) Pub. Date: Mar. 19, 2009

(54) METHOD, SYSTEM AND COMPUTER PROGRAM FOR GENERATING FINANCIAL TRANSACTION INSTRUCTIONS

(76) Inventor: Joseph Szamel, Budapest (HU)

Correspondence Address: MILLER THOMPSON, LLP, Scotia Plaza, 40 King Street West, Suite 5800, TORONTO, ON, M5H 3S1, CA

(21) Appl. No.: 11/857,913

(22) Filed: Sep. 19, 2007

(51) Int. Cl. G06Q 40/00

(52) U.S. Cl. 705/39; 705/35

(57) ABSTRACT

A method, system and computer program is provided for enabling on-line generation of financial instructions by a financial institution account holder and/or a signatory authorized to access his/her financial institution account. Hand written data provided by a user on a medium is digitized, such medium optionally including a digital pattern, by operation of a digital pen. The data is provided at communication device, and then to a server computer associated with the financial institution, the server computer being operable to interpret the data as financial instructions. The financial institution processes the financial instructions, and optionally generates feedback, which is made available to the communication device. The server computer enables the processing one or more financial transactions based on the financial instructions.

### FIELD OF THE PRESENT INVENTION

The present invention relates to methods and technologies for supporting on-line banking and in particular for supporting and enabling on-line generation of financial transaction instructions by financial institution account holders and/or signatories authorized to access their financial institution account.

### BACKGROUND OF THE PRESENT INVENTION

In this disclosure, “financial institution” means any organization in the business of moving, investing or lending money, dealing in financial instruments, or providing financial services.

Financial institutions such as banks and depository institutions include commercial banks and consumer institutions. These are institutions that are able to receive deposits from their customers. Typically they deal with money, hold money, invest money and lend money. The most important type of these institutions are commercial banks and similar organizations such as credit unions, trust companies and savings and loans, which accept deposits from, and deal directly with, consumers. Money transmitters are also considered part of this group because they accept deposits and hold funds until they are transmitted to a final destination.

Commercial banks are the institutions that are by far most numerous and involve the largest number of customers, and, as distinct from central banks and investment banks, offer a broad range of products and services to both individuals and businesses including: chequing and savings accounts, time deposits and loans. Within commercial banks, retail banking is the part of the bank's operations providing services to individual customers, as opposed to businesses.

A bank's retail operation generally has by far the broadest interaction with customers. Day-to-day banking activities are the ones experienced by the vast majority of customers on a frequent basis such as management of chequing or savings accounts, cash withdrawals and deposits, payment of bills, and the like. Depending on the individual customers, other products such as overdrafts and consumer credit, including credit cards, debit cards and even insurance products and real estate transactions may also require frequent interaction.

A credit union is generally a financial cooperative organization of individuals with a common affiliation such as employment, labour union membership or place of residence. The organization is typically a non-profit corporation owned and operated by its members. Credit unions generally offer similar products and services to those provided by a bank's retail arm, including accepting deposits and providing credit card and loan facilities. The offering is not usually as broad as that of the banks and the customer base is generally limited to membership in the credit union. Trends in the credit union business are similar to those in banking and focus on increasing automation while maintaining customer satisfaction. Credit unions continue to expand their product offering including mortgage lending and credit cards. Some have also relaxed membership requirements in an effort to attract more members.

Savings and loans (“S & L”), also called Thrifts, are a type of depository financial institution found in the United States. An S & L accepts deposits from consumers and holds the majority of its assets in home mortgages. They are often mutually held (often called mutual savings banks), meaning the depositors and borrowers are members with voting rights and have the ability to direct the managerial goals of the organization. In some cases a savings and loan can issue stock and be publicly traded and members no longer have direct managerial control. Today, S & L's are virtually indistinguishable from banks in their product offerings and some even call themselves banks. One key difference is the S & L's focus on marketing themselves as community-oriented, home-lending specialists. Beyond this, automation and other trends are similar to those in the banking industry.

A trust company is either a type of commercial bank or a division of a bank, which specializes in being a trustee of various kinds of trusts and managing estates. Historically, trust companies had to be operated as stand-alone companies, separate from banks or other companies. Since this is no longer required, trust companies are usually divisions of a bank or other financial institution that provides the services associated with the original trust companies. Modern-day trust companies act as trustees—someone who administers financial assets on behalf of another. A trustee will generally manage investments, keep records, manage assets and prepare court accounting, pay bills and distribute income and principal as stipulated in the individual trust agreement. In some countries, like Canada, trust companies can also offer day-to-day banking services to consumers. Although independent, trust companies offer many bank-like services, the nature of trust agreement work usually requires personal interaction. These companies are therefore generally limited in how much automation they can incorporate.

Money transmitters are specialized deposit institutions that may focus on sending or transmitting money to other locations. While other services may be provided, the typical transmitter may accept a deposit at a local office and charges a fee for delivering the equivalent amount in local currency to a location of the depositor's choice. Transmitter companies are usually corporations and may be owned by large financial institutions like AMERICAN EXPRESS™ or WESTERN UNION™. Like bank branches, money transmitters' locations are also numerous. They typically serve the needs of expatriates and/or immigrant workers who remit money back home. In the U.S. and Canada, there are, for example, many migrant farm workers who remit money regularly to their homes in Mexico, Central America or elsewhere. The practice is quite prevalent throughout the world, and in some countries remittances from citizens working abroad is one of the single largest sources of foreign exchange. Countries like India, Pakistan, the Philippines, Bangladesh, etc. supply large parts of the labour pool in oil-wealthy middle-eastern countries. Because of this, money transmitter offices are quite large in number.

Financial institutions consider management of payment instructions to be highly important among their service offerings. The ratio of electronic payment transactions has risen sharply at the expense of cash payments over the past few decades. The importance of effective processes and supporting technologies for generating financial payment transactions and other financial instructions is well known. For example, many banks around the world have invested and continue to invest heavily in providing the infrastructure that ensures their customers have proper access to the services of their trusted financial institutions, especially outgoing payments. Security and ease of access to payment services are the most important guiding principles banks try to abide by when it comes to providing payment services to their customers. Banks invest heavily into extensive (and costly) branch networks, call centers, on-line banking solutions, telebanking, cheque payment systems infrastructure etc. in order to provide convenient and accessible services to their customers among which outgoing payment processing is crucial. Financial institutions and their customers engage in numerous financial transactions, including cheque processing, bill payment, and electronic fund transfer.

Cheque processing is one of the oldest legacy systems left in the banking services sector. Tens of millions of people and businesses worldwide are writing billions of pieces of paper to each other, using a payment system that is over 200 years old. Cheque processing is labourious and process intensive, as such, it can be an expensive activity for financial institutions. This is particularly the case given the relatively complex and resource intensive clearing rules and record keeping requirements associated with paper cheques. By stating only the name of the beneficiary, traditional paper cheques do not uniquely identify the payee, therefore, in order to complete the customer identification, so that the payment transaction can be processed, the cheque may be required to be presented at the branch of the payee (beneficiary). This leads to the slow, inefficient clearing rule process, which is also relatively open to fraud.

However, despite all the shortcomings, cheque processing is a critical part of the financial infrastructure. Cheques are often considered by many as a completely off-line home banking system (‘Bank in the Pocket’) that usually requires a massive infrastructure to support. In summary, related prior art systems are generally rather slow, expensive, cumbersome, open to fraud, and wasteful of expensive financial institution resources.

Cheque processing typically may consist of the following operational tasks:
Mailing a cheque completed by the payer to the beneficiary who passes it to his/her bank,
establishing the identity of the beneficiary (payee),
establishing proof of authenticity,
sending the cheque to a central clearing centre by beneficiary's bank,
exchange between banks,
scanning the cheque and returning it to the payer's bank (branch),
decision regarding payment is made at the branch and payer's account is debited,
payment amount cleared with the payer's bank: settlement,
mailing the processed cheque to the payer for filing,
dealing with dishonours/bounced checks, and
seven years of archiving.

One of the most significant steps in paperwork processing is the cheque imaging i.e. turning the paper cheque format into digitized information which is easier to access, move, store and archive.

From the time that the payee receives the payer's cheque, it might take as long as 5-10 days for the payee to receive confirmation that the payer's cheque has cleared. The payee in such a case has an option of providing his/her services while at a financial exposure or hold off providing services until payment confirmation has been received.

The business processes of financial institutions generally require that information subsumed in a paper cheque be digitized. This process of data digitization can be quite costly given the number of cheques involved. This is driving the need for technology enablement of the manner in which customers provide instructions to financial institutions.

Wire transfer is a newer and far more efficient method of payment. Wire transfers are generally less prone to errors and fraud, they are less labour intensive and less expensive to process, and also they may be close to or real-time. Financial institutions provide access to electronic payment services in various ways, such as wire transfer forms that can be filled out in their branches, or outside of a branch and subsequently mailed in. However, as explained below, the current technology for processing wire transfers is still relatively resource intensive.

In comparison to cheque processing, electronic wire transfers are usually simpler, faster and more secure. Typical processing steps are as follows:
payer fills out the wire transfer form at the bank branch and hands it over to the teller,
teller verifies the identity of the payer, checks the validity of the bank account number and the available balance,
if all positive, teller accepts the transfer instruction, stamps the wire transfer form and hands a copy over to the payer,
payment information contained on the wire transfer form is entered into a system for payment by a back office clerk and payment is made,
payee generally receives the funds the business day following the payment date (could be as fast as same day), and
seven years of archiving.

In addition to supporting wire transfers, many financial institutions provide system facilities for on-line payment transactions such as bill payments, whether operated via dial-up, Internet or other types of connections via different types of devices, like personal and/or laptop computers, or PDAs. Also, financial institutions often offer payment facilities via their call centres, telebanking services, etc.

There is a comparative reduction in cost to financial institutions if customers use such non-paper based means of processing financial transactions. Therefore financial institutions are generally interested in encouraging customers to utilize Internet banking or electronic funds transfer (“EFT”), over traditional payment methods involving paper cheques or visits to brick-and-mortar financial institution offices. Even the costs associated with call centres (such as labour, technology infrastructure and maintenance) are relatively high.

Many customers, however, resist the use of technology for the purpose of transacting with their financial institution. For some, the paper cheque continues to be an effective technology, in part because the carbon copy of a cheque often created at the same time the cheque is written provides an instantaneous back up and record of the transaction. Some customers do not have access to a computer for banking purposes, and in fact providing a computer, and then updating a computer, with appropriate security technology can be costly and time consuming. Also, while the security features of a paper cheque are not particularly robust, the signature on a cheque at least provides means for identifying a cheque forged by a third party. General speaking, it is somewhat more difficult to prove (based on security features generally used), that an electronic transaction was fraudulent once a third party has obtained a customer's log-in information (through Internet phishing or otherwise).

Also, some customers who do have access to a computer demand the flexibility of being able to initiate financial transactions with their financial institution without having their personal computer on hand, for example, while traveling. Also, even when customers are carrying a laptop, for example, Internet connectivity can be an issue in some locations.

It should be understood that financial institutions are also interested in creating opportunities for cross-selling financial products and services in conjunction with particular financial transactions. For example, financial institutions are interested in identifying attributes of a particular set of financial instructions (e.g. pay $10,000.00 to an auto dealership) in order to offer, for example, insurance to the customer. The ability to leverage such cross-selling opportunities depends on being able to capture data concerning the customer's financial instructions in real time or near real time.

There is significant competition between financial institutions for customers, especially for the best customers. One way in which financial institutions compete with one another is by bundling services, thereby providing greater convenience to customers.

Financial institutions make significant investments in ensuring that their services are easily accessible. They build branches, they provide costly ATM networks, on-line systems, call centres, and bank card systems (including point of sale payment technology). They are also interested in providing financial solutions that are secure. However, often ease of access and security are in conflict, i.e. the easier access usually creates more security problems. This is especially true in the Internet based on-line environments.

It should be understood that financial transactions also include money transactions such as payroll payments. In this case, the financial institution involved may be a bank, but it also may be a payroll organization that operates a financial institution or works with a financial institution. Financial institutions, in accordance, with the present disclosure include the various businesses with whom such financial transactions are processed.

There is a need therefore for solutions that provide a technology enabled means for customers to create instructions to financial institutions that is low cost, simple to use, accessible, does not depend on technology infrastructure that is difficult to maintain, is based on widely available network connectivity, and that provides improved security. There is also a need for such solutions that create cross-selling opportunities for financial institutions and the added convenience of bundling of financial service offerings to customers.

U.S. Publication 2004/0083174 A1 was filed Apr. 29, 2004 and is entitled a “Method and System for Banking using Coded Forms”. This publication teaches an online banking system, and particularly, the use of a netpage pen which interacts with coded data on a printed netpage and communicates via a short-range radio link with a netpage printer. However, it is the printer that sends the interaction to the relevant netpage server for interpretation, thus requires expensive network infrastructure comprised of netpage printers, and computer connectivity. There is a need for a less expensive and more versatile solution, and which does not require the use of coded data as disclosed in U.S. Publication 2004/0083174 A1.

### BRIEF DESCRIPTION OF THE DRAWINGS

A detailed description of the preferred embodiments is provided herein below by way of example only and with reference to the following drawings, in which:

FIG. 1 is a schematic diagram illustrating components of a system in accordance with the present invention.

FIG. 2 is a flow chart illustrating method steps in accordance with the present invention.

FIG. 3A, FIG. 3B and FIG. 3C illustrate a digital pen connected with a communication device in three different embodiments thereof.

FIG. 4 is a schematic diagram illustrating back end systems in greater detail.

FIG. 5 illustrates an example of a traditional cheque.

FIG. 6 illustrates an example of a traditional wire transfer form.

FIG. 7 illustrates an example of a digital wire transfer form for a particular application of the present invention.

FIG. 8 illustrates an example of a digital cheque form for a particular application for the present invention.

FIG. 9 illustrates an example of a digital cheque form template for a particular application for the present invention.

FIG. 10 illustrates an example of a digital wire transfer form template for a particular application of the present invention.

FIG. 11 illustrates an example of a digital payroll set-up form for a particular application of the present invention.

FIG. 12 illustrates an example of a digital payroll payment transaction form for a particular application of the present invention.

FIG. 13 illustrates an example of a digital recurring payment set-up form for a particular application of the present invention.

FIG. 14 illustrates an example of a digital recurring payment transaction form for a particular application of the present invention.

In the drawings, certain aspects of the present invention is illustrated by way of example. It is to be expressly understood that the description and drawings are only for the purpose of illustration and as an aid to understanding, and are not intended as a definition of the scope, areas of application, and/or limits of the present invention.

### DETAILED DESCRIPTION OF THE PRESENT INVENTION

The system of the present invention is best understood as an on-line interactive facility for financial institution account holders and/or signatories authorized to access their financial institution accounts, to generate financial instructions for execution by their financial institution. The system of the present invention is operable to capture information related to financial instructions provided by a user in connection with a paper form (provided using some form of “digital paper” and corresponding to a digital form, as explained below) that embodies one or more financial transactions; and transmit this information to a system of the financial institution (referred to as the back office system in this disclosure). The information is received by the back office system and processed by the back office system in accordance with the applicable business rules defined by the financial institution for the particular financial instructions and related financial transactions.

It should be understood that the present invention is not meant to be exhaustive as to the particular financial instructions and paper forms (and corresponding digital forms). For example, the financial instructions can relate to various financial transactions normally relevant to financial institutions, including for example: (1) account management (savings, chequing, or other accounts): including opening an account, closing an account, depositing funds, withdrawing funds, cashing cheques, transferring funds between accounts, and obtaining account balances; (2) making payments (utility bills, taxes, credit card bills, or other payments): via debit card, credit card, direct debit, personal or business cheques, certified cheques, in cash, and wire transfer; (3) credit arrangements/applications: including overdraft, line of credit, letters of credit, personal loan, vehicle loan, mortgages, applying for credit or debit card, and increasing credit card limit. The financial transactions also include other transactions that generally involve payment or some other link to a financial institution such as payroll processing, which example is explained in greater detail below.

In one aspect of the present invention, a method for enabling on-line processing of instructions by a financial institution is provided, the method comprising: digitizing handwritten data provided by a user on a medium, receiving the data at a communication device, transmitting the data to a server computer associated with the financial institution, the server computer being operable to interpret the data as financial instructions, the financial institution processing the financial instructions.

In another aspect of the present invention, a method for enabling on-line generation of electronic financial instructions for electronic processing by a financial institution is provided, the method comprising: (a) digitizing hand written data provided by a user on a medium, such medium optionally including a digital pattern, by operation of a sensing device; (b) providing the data at a communication device; (c) providing the data to a server computer associated with the financial institution, the server computer being operable to interpret the data as financial instructions; and (d) the financial institution processing the financial instructions, and optionally generating feedback, which feedback is made available to the communication device.

In another aspect of the present invention, a method for enabling on-line generation of financial instructions is provided, the method comprising: (a) defining (i) a digital format associated with one or more paper forms and/or business rules embodying a financial transaction, and (ii) a transaction form associated with the digital form on a medium that is interoperable with a digital pen; (b) defining a processing template based on the financial transaction; (c) receiving data from a financial institution account holder and/or signatory to the financial institution account, wherein the data is generated by the digital pen in conjunction with the transaction form, and wherein the data includes financial instructions; (d) comparing the data with the processing template; and (e) processing the financial transaction, and optionally providing feedback to the financial institution account holder and/or the signatory to the financial institution account.

In a further aspect of the present invention, a system for enabling the generating of outgoing payment instructions for a signatory to a bank account located remotely from the financial institution, the system comprising of a digital sensing device operable to generate electronic data when used with a transaction form embodying one of more steps of an associated financial transaction, a communication device linked to the digital sensing device for transferring data over a network to back office systems; wherein the back office systems transmit to the signatory to the bank account feedback regarding the payment request instructions generated.

In yet another aspect of the present invention, a system for enabling the generation of online financial instructions from a financial institution account holder and/or a signatory to the financial institution account located remotely from a financial institution is provided, the system comprising: (a) a digital pen operable to generate electronic data when used with a transaction form that embodies one or more steps of an associated financial transaction; and (b) a communication device linked to the digital pen, the communication device operable to transmit data over a network to a back office system of the financial institution; wherein the back office system is operable to process financial instructions related to the financial transaction and embodied in the electronic data, and is further operable to optionally transmit to the account holder and/or the signatory feedback regarding the financial transaction.

In yet another aspect of the present invention, a computer program for enabling the generation of online financial instructions from a financial institution account holder and/or the signatory of the financial institution account located remotely from a financial institution, is provided, the computer program being for use on a server computer, the computer program comprising: (a) a computer usable medium; and (b) computer readable program code recorded or storable in the computer useable medium, the computer readable program code defining a server application on the server computer that is operable on the server computer to establish an application program interface; wherein the application program interface includes a data extraction module operable to receive data from a communication device over a network, the data being generated by a digital pen in connection with a transaction form that embodies one or more steps of an associated financial transaction, wherein financial instructions are embodied in the data, and the application program interface is operable to make the financial instructions available for a back office system associated with the financial institution to process one or more financial transactions based on the financial instructions.

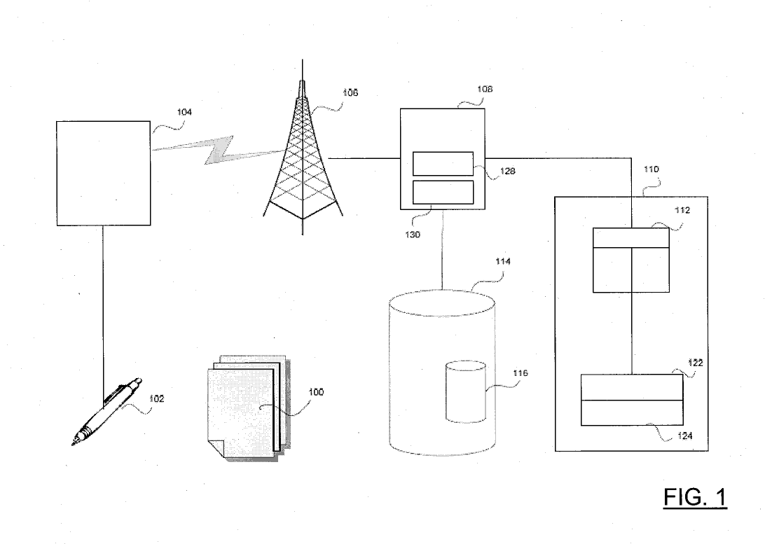

As best illustrated in FIG. 1, the system of the present invention generally includes: (i) a paper form (100) that enables a user to provide one or more financial instructions to a financial institution. For example the paper from (100) comprises a digital cheque or digital payment transfer form or wire transfer form; (ii) a digital pen (102); and (iii) and a communication device (104).

The paper form (100) corresponds to a data set (not shown) associated with the back office system (110) that enables the information embodied in the paper form (100) to be processed properly by the back office system of a financial institution, such as a bank, credit union or the like (110). In one particular embodiment of the present invention, the data set defines a digital form (101), corresponding to a particular paper form (100), and that is interoperable with the back office system (110) to process a financial transaction based on the financial instructions provided by a user, and also optionally based on the business rules defined on the back office system (110) by the financial institution.

In one aspect of the invention, the aforementioned financial transactions may be made through the use of a sensing device such as a digital pen (102) that is interoperable with the paper form (100) (as explained below) to enable data to be captured from the paper form (100) in real time or near real time based on indicia or markings made on the paper form (100) by a user. In one particular aspect of the present invention, this is achieved by providing the paper form (100) using a known digital paper technology (explained below). The use of digital paper enables the transaction information to be substantially instantly digitized with relatively little communication and processing infrastructure.

“Digital pen” (102) in this disclosure generally refers to a prior art digital ink pen, which preferably incorporates a conventional ink pen as well as a digital pen (102) such that a user can write on a paper form and the writing is simultaneously captured digitally by operation of the digital pen (102). Examples of such pens are those marketed by MAXELL™, LOGITECH™ (for example the IO2™ pen) or the SU-1B BLUETOOTH™ Digital Pen of NOKIA™.

In another aspect of the invention, digitization can be achieved by traditional scanning replacing the digital pen. Subsequent interpretation of the scanned data can be achieved using software products like Recognita.

The terms “user” and “customer” are used interchangeably in this disclosure.

It should be understood that while this invention refers to “digital paper” in a number of locations, it is not essential that the forms of the present invention be provided using a particular digital paper technology. One of the more ubiquitous “digital paper” technologies is marketed under the brand ANOTO™. The ANOTO™ technology includes a paper surface that is overlaid with a digital pattern consisting of a pattern of small dots printed on the paper surface such that the pattern is unique within the paper surface within localized areas. In combination with a digital pen (102), when a user marks the paper surface, the built-in sensor such as a digital camera of the digital pen (102) captures images of the marks in combination with the digital pattern, thereby enabling the marks to be associated with specific locations on the paper surface. Using known character/handwriting recognition software, images of marks are turned into digitized information and processable data. In addition to the ANOTO™ type technology discussed above, means can be provided, for example, that enable a user to select a particular digital form (101) that corresponds to a paper form (100), and then to establish a starting point on the paper form (100), which is then correlated to the digital form (101) whereby subsequent entries on the paper form (100) are associated with the corresponding fields on the digital form (101).

The ANOTO™ pattern of dots provides a grid in order to identify positions on the form, with a user filling out the form by writing upon the form as disclosed. The ANOTO™ digital paper requires character/handwriting software so as to disclose the writing thereon and does not comprise coded data. The ANOTO™ base technology is described in U.S. Pat. No. 5,852,434. The digital pen is one of the tools for digitizing the handwritten data. However, as outlined above, other digital paper technology can be utilized.

In addition, the transaction information can also be encrypted, in a manner that is known. Certain security aspects of the present invention are discussed below under the heading “Security/Authentication”.

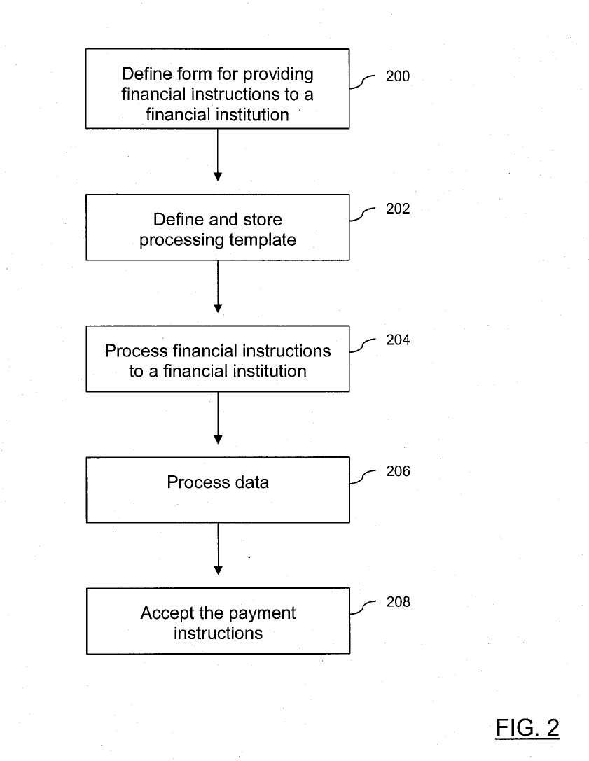

As depicted in FIG. 2, the steps according to the method of the present invention, in one aspect thereof, consist of:

(A) Defining a paper form (100) for use by a user and a corresponding data set (or digital form (101)) interoperable with the back office system (110) of a financial institution, for enabling a user to provide financial instructions by marking the paper form (100), for providing financial instructions to a financial institution such as a digital cheque, digital payment transfer or digital wire transfer form (in a representative embodiment of the invention as explained below) (200).

(B) Defining as well as storing a processing template for processing the financial instructions captured digitally from the paper form (100) (such as for example payment data captured from a digital cheque or digital payment transfer form or wire transfer form) and storing the processing template to a database (116) linked to the API (Application Program Interface) (108), which API (108) is linked to the back office systems (110).

(C) Processing the financial instructions by operation of the back office system (110) based on information provided by operation of the paper form (100) and based on the processing template in accordance with step (B) described above, by sending (and optionally receiving) the information via the communication device (104). It should be understood that one aspect of the present invention consists of the user obtaining necessary feedback (204) from the financial institution in response to the financial instructions provided. Examples of such feedback are provided below.

(D) Accepting the financial instructions by operation of the back office system (110) and thereby processing the financial transaction corresponding to the paper form (100). By operation of the present invention, processing of the financial transactions can occur in real-time, or near real-time. The back office system (110) is operable to initiate, in response to processing of the payment instructions, one or more post-transaction processes, including for example generation of a financial transaction identifier and time stamp, reflecting for example the processing of the financial transaction in accordance with the normal financial transaction processing rules of the financial institution (e.g. in accordance with payment clearance rules of the financial institution). The post-transaction processes may result in the back office system (110) sending a reporting message by means, for example, of Multimedia Messaging Services (MMS), Short Messaging Service (SMS), e-mail or the like, to the communication device (104) of the user.

It should be understood that the method as illustrated above, and in accordance with FIG. 2 is provided as an example only and is not meant to be a limitative description of the method of the present invention. Depending on the particular financial transaction involved, or the particular processes of the relevant financial institution, changes may be made to the above described method in a manner obvious to those skilled in the relevant art.

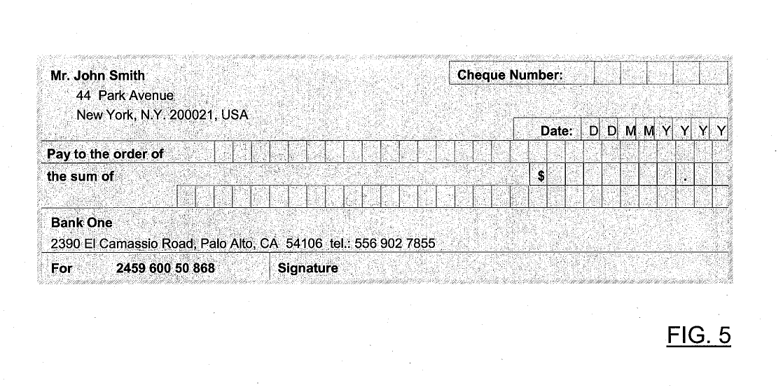

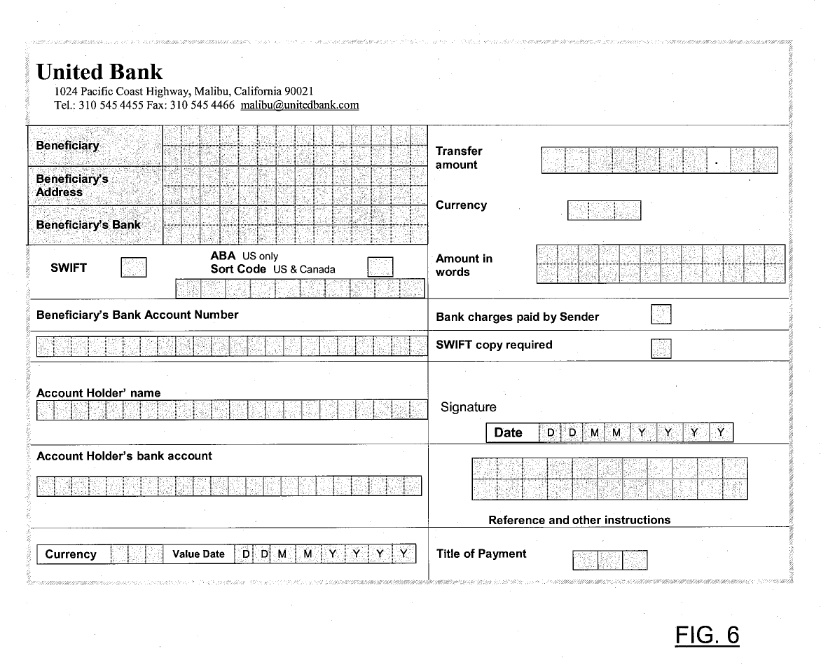

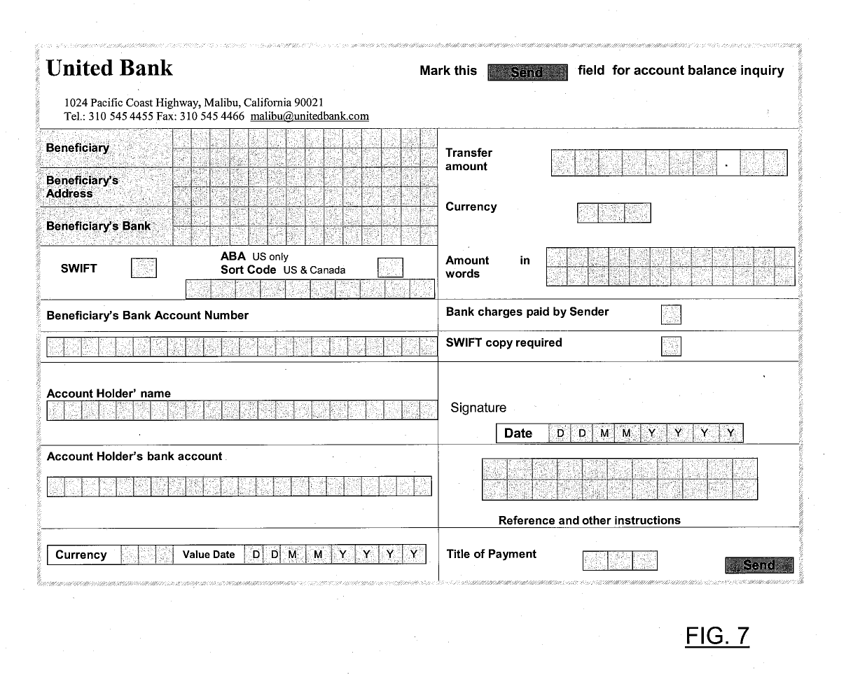

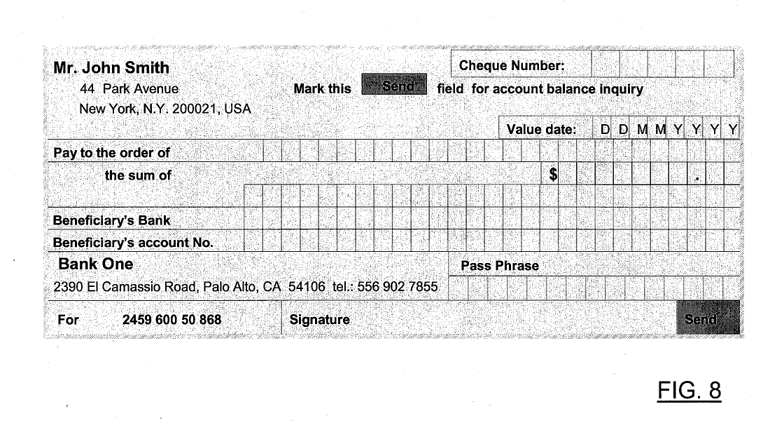

In another aspect of the present invention, a design phase is provided that relates to designing the particular paper forms (100) and corresponding digital forms (101), in order to apply the present invention to the various financial transactions. This design phase is readily applied, as is illustrated by the examples of two particular paper forms (see FIG. 5, FIG. 6) (100) and corresponding digital forms (see FIG. 7, FIG. 8) (101), in one particular embodiment of the present invention, namely a wire transfer form or a “digital cheque”.

The wire transfer form illustrated in FIG. 6 is best understood as a paper form (100) that enables a user to fill out the information normally provided as wiring instructions to a financial institution, i.e. to draw funds from an account held by the user with the financial institution and wire these funds to a specified payee. A “digital cheque” is best understood as a replacement for the traditional cheque commonly used by customers of a financial institution to draw funds from a bank account, for payment to a particular payee, using the present invention. In many cases, such cheques or wire transfer forms used by financial institutions are designed to contain all information necessary to complete the relevant outgoing payment transactions. The design/structure of the digital wire transfer form (see FIG. 7)/digital cheque (see FIG. 8)/(100) may be established in order to ensure that it conforms to the rules of processing the relevant financial transactions applicable to the particular financial institution in the relevant circumstances. Therefore one particular aspect of the design phase is establishing the information that is required by the back office system (110) of the particular financial institutions(s) involved in order to enable the execution of the relevant outgoing payment transactions. Once that information (i.e. the content of the cheque and/or payment transfer/wire transfer form) is known, the layout/sequence of the data fields may be established in conformity with executing the outgoing payment transactions, in a manner that will be obvious to those skilled in the relevant art.

Subsequent to the finalization of the layout for the particular paper form, the form is “overlaid” with a digital pattern as described above and allocated to the digital payment transfer/wire transfer form (see FIG. 7) or particular digital cheque (see FIG. 8) in order to enable the digital capture of the information marked on such paper forms (100), as described above. The digital pattern can be unique for each individual digital cheque or wire transfer form, or for each batch of forms, depending on the business requirements of the particular financial institution.

The design of a digital form (100), such as a digital cheque (see FIG. 8) for example, preferably conforms to the requirements of the particular financial transaction and related business rules for processing same, which in the case of an outgoing transaction processing scheme may involves the following:

(A) Identifying the financial institution account holder/signatory (i.e. the user) providing the information captured on the form. The identification step is discussed in greater detail under the heading Security/Authentication below.

(B) Processing the financial transaction, in this case the processing of the payment referenced in the digital cheque or wire transfer form of the present example. The processing of the financial transactions may occur in accordance with the business rules of the financial institution (which are generally embodied in the operations of the back office system (110), as well as the business rules of the financial institution of the payee and any intermediary institutions.

There are numerous methods for managing outgoing payments. In one aspect of the present invention, the processing of a digital cheque or wire transfer form generally involves initially verifying that the account balance of the user is sufficient to cover the amount of the payment requested by the user. In one particular aspect, the present invention is operable to provide feedback to the user by means of messages sent by the messaging system associated with the back office system (110) (e.g. a text message, or email), for example, in the event that the balance of an account of the user is not sufficient to cover the payment requested. In this scenario, for example, a message containing the current balance of the user may be sent to the communication device (104), and the original financial transaction is cancelled (no debit to the user's account), and the user is invited to generate payment instructions in regard to an alternate amount.

(C) Performing various updates related to transaction history, payment history, financial institution account statements etc. (e.g. by operation of the back office system (110)). In one particular aspect of the present invention, the API (108) is operable to interface with a messaging system linked to, or part of, the back office system (110) that is operable to send a communication message to the communication device (104) of the user regarding the fulfillment of his/her payment instructions (and possibly also to the payee regarding the credit transaction to his/her account).

(D) Crediting the payee's financial institution account with the transfer amount, and initiating settlement between the financial institution of the user and that of the payee as per the applicable clearing rules or equivalent.

It will be appreciated by those skilled in the art that the aspect of the invention described above may apply to any other method or form of generating outgoing payment instructions without departing from the scope of the present invention. It should be understood that various other forms and industry applications of the present invention are possible.

As further particularized below, the present invention provides a system, method, and computer program that enables a user to engage in the various financial interactions that are common between a client and a financial institution without the need to attend at the business premises of the financial institution, and without the need for expensive or difficult to maintain technology infrastructure, and without depending on computer connectivity, which can sometimes be problematic. The user is consequently offered a series of technology enabled financial transactions without a significant departure from existing, familiar paper based interactions.

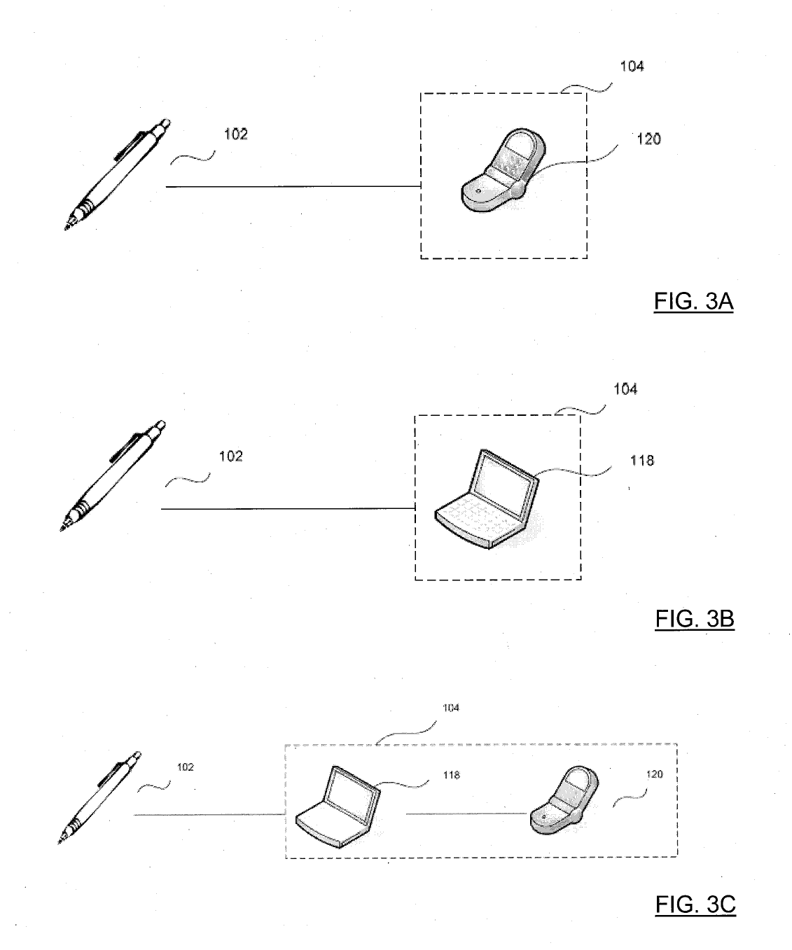

The present invention makes financial institution account holders technology-enabled thereby allowing data to be captured quickly and inexpensively in connection with transactions involving paper that would normally require time consuming and expensive processing and/or subsequent approval or authorization. The overall processes involved in the digitization of information in accordance with the present invention are illustrated in FIG. 3A. With most financial institutions, a traditional paper cheque, for example, is digitized, which usually involves manual keying of data, or digital processing of data with manual verification, in order to ensure accuracy. This is a requirement as the transaction methods used by most financial institutions are now digital based. Especially to address the issue of non-repudiation of the financial transaction by the user, and also to provide users the convenience of availability of a back up of the forms that were used to initiate financial transactions, financial institutions generally capture an image of cheque or wire transfer instructions (including the applicable signatures). The resources (e.g. time and storage) involved in capturing, organizing, storing this information, and making the information available upon request, are often significant. Within most financial institutions these activities require the creation and maintenance of an entire related infrastructure, the cost of which may not be generally fully recouped by user fees, and therefore generally affect the bottom line of financial institutions.

It should be understood that in the case of the digital cheque aspect of the present invention, since the digital cheque itself is not a negotiable instrument unless the “NEGOTIABLE” field is marked as per FIG. 8 The fact that, with the present invention, all information that may be required to approve and execute an outgoing payment instruction exists on paper in written format means that the system of the present invention can also serve as a back-up solution that can be processed as a ‘traditional cheque’ in case there is a network failure disabling communication between the user and the financial institution, or any other system break-down.

The present invention allows financial institutions to deliver their payment instruction generation capabilities and services to the ‘door step’ of their customers and complete the entire cycle of outgoing payment instruction generation on-the-spot, inclusive of digitized data capture, the capturing of customer's signature, data transfer, data validation and confirmation of date and time of payment, establishing of new available balance and the like.

It also should be understood that financial institutions typically have well-defined processes for approving financial transactions, including for example analyzing paper documents (such as cheques) prior to authorizing any outgoing payment requests. The approval of cheques or wire transfer forms for payment, for example, often involves analysis of signatures, or at least comparison for reasonable similarity to signatures on file. This analysis often involves staff with specialized expertise.

In this respect it should be understood that the verification of the identity of the user based on the various means of identification discussed above can provide a similar level of verification as the prior art analysis referred to above but at much lower cost. Also, the verification that is possible specifically based on the markings made using the digital pen (102) is generally superior to manual verification. Manual verification is based on the way a given signature looks, however, signatures captured by a digital pen (102) may contain so called pen stroke information inclusive of direction, pressure, speed of movement at each pen stroke, starting point of writing every letter, the angle of the pen at each pen stroke and the like.

It should be understood that one of the advantages of the present invention is that it delivers anytime/anyplace convenience of engaging in financial transactions with financial institutions (including using financial institutions as intermediaries with other parties). In one particular aspect of the invention, the processing of a financial transaction by a financial institution, as described can result in confirmation of a transaction (for example by the financial institution providing a transaction approval number, approval certificate, or approval token—in a manner known to those skilled in the art), which confirmation can be used by customers of financial institutions to verify that a financial transaction has concluded as requested. This confirmation may then be relied on by third parties in related transactions. For example, where a user is seeking a third party to transfer title to goods, or to provide a services, but such events are contingent on payment, confirmation provided in accordance with the present invention can be relied on. It should be understood that many financial transactions involving cheques, where clearance rules may need to be taken into consideration, require several days to be fully processed. This produces an inefficient result and has implications on the various related transactions, which depend on confirmation of payment (including as described above). The present invention provides an efficient means for addressing this issue.

In accordance with one aspect of the present invention, upon conclusion of a financial transaction by operation of the present invention, an icon can be presented on a display (not shown) of the communication device (104) along with information related to the confirmation of the completion of the transaction. This can be shown to a third party who wishes to rely on the conclusion of the transaction in order to enter into a further transaction with the user, as described above. Also, the financial institution may provide a transaction form allowing the payer to define the physical or electronic address (e-mail, cellular phone number) of the beneficiary (payee) for sharing the transaction confirmation message.

It should be understood that the paper forms (100) contemplated by the present invention, may embody specific steps of financial transaction (such as the steps of an outgoing electronic payment process), including obtaining feedback related to the certain financial instructions, payment instruction generated from a remote office in real-time or near real-time.

The system of the present invention may therefore be operable to: (i) capture and digitize written information obtained during the generation of the outgoing payment instruction; and (ii) transfer the data captured digitally and optionally encrypted to one or more remote computers defining back office systems (110) according to pre-defined rules (116) that support the processing of outgoing payment transactions, e.g., identification of the financial institution account holder/authorized account signatory, validation of the account number, withdrawal amount, payment date and signature of the initiator of the outgoing payment instruction (account holder or signatory).

In another aspect of the present invention, the business rules defined by the financial institution may invoke various forms of support processes depending on a number of factors such as the nature of the financial instructions and the customer profile of the user providing the instructions.

This support may be provided, for example, in the form of an email message; for instance an SMS sending the remaining account balance information to the communication device (104); or a call to the communication device (104) to provide assistance or advice concerning certain aspects of the financial transaction, or possibly even related transactions. All of these opportunities to provide support exist in real-time or near realtime as part of the present invention, which permits financial institutions to provide more meaningful service to their customers.

In addition, financial institutions are often interested in cross-selling additional services, and particular transactions, are often triggers for particular cross-selling opportunities. For example, the purchase of an automobile is an opportunity to sell insurance, and many financial institutions have their own, or distribute third party, insurance products. There may be a time delay in the submission and processing of cheques, which reduces the ability of financial institutions to react to particular transactions that could trigger opportunities to cross-sell other products or services. This time delay may be important in that with the passage of time the compulsion or motivation to make a particular purchase may have passed or is less pronounced, thereby reducing the likelihood of closing the transaction. In contrast, the present invention enables a financial institution to link these activities to particular transactions. By way of example, outgoing transactions over an amount or to a certain recipient may trigger an SMS message for example inquiring as to whether the customer is interested in speaking with a representative concerning certain related products or services.

In other words, the present invention facilitates a contact between the financial institution and the user, its customer, and thereby enabling an interactive session between them at the point and time of sale. If, for instance, the customer issues a cheque in the exact amount of $1,000 dollars to a car dealership using the current invention, there could be reasonable grounds to assume that s/he is considering to purchase a vehicle and has just made a down-payment. Such conclusion should trigger the marketing systems of the financial institution to generate relevant messages to the customer regarding available automobile loan and insurance products specifically tailored to the specific customer/occasion. In another example, in the event that the customer makes a wire transfer to an airline using the present invention, the financial institution can relay a message(s) to the communication device (104) of the user regarding a credit card offering, or travel insurance, or other types of financial services offerings that might be available for travel. Based on the amount transferred, the marketing systems of the financial institution may be able to estimate the distance of the travel, allowing tailored messages to be formulated.

### Security/Authentication

As explained in part below, the present invention contemplates the use of means for authenticating the identity of the user (for example to the back office system (110)), authenticating the paper form (100) as being an authorized paper form, and/or securing data or communications as between the communication device (104) and the back office system (110). Particular implementations of such security or authentication are discussed below.

It should be understood that the present invention contemplates the use of various means of encryption or authentication, including for example the use of standard (including proprietary) encryption products or methods, as appropriate depending for example on the user requirements at hand, or the requirements of the financial institution.

In one particular implementation, the system of the present invention may use one or more of a variety of means for identifying the user: (i) a pen identifier (i.e. a code embedded in and sent by the digital pen (102) as part of each data transmission, (ii) digital cheque pattern identifier (i.e. an aspect of the digital pattern that identifies the particular digital cheque or batch of digital cheques, (iii) phone number associated with the communication device (104) that is also sent as part of each data transmission, (iv) a bank account number associated with the user, and/or (v) a biometric signature applied by the user. In one particular aspect of the present invention, the means for identifying the user may be known to the financial institution and the back office system (110) and includes means for matching such identifiers with the user, thereby authenticating the user to the back office system (110) for the purpose of processing financial transactions in accordance with the present invention. Besides handwriting authentication, using the current invention, financial institutions may also authenticate the digital pen itself using a Pen-ID issued to the customer or equivalent against the Pen-ID used for the given data transmission. For clarification purposes, the present invention contemplates the use of combining more than one of the identification means listed above, e.g. a pen identifier with a digital identifier cross-referenced with a paper form identifier, or by cross referencing a pen identifier, a paper form identifier and a phone number associated with a communication device.

It should be understood that this information can be stored in the database (116) as part of a customer record by the back office system of the financial institution and then retrieved for identification purposes by an identification utility (not shown) that is part of, or linked to, the back office system (110).

It should be understood that using the methods described above, as well as additional authentication methods, the identity of the user providing the financial transactions (such as outgoing payment instructions in accordance with the digital cheque or wire transfer form examples) may be established with relatively high certainty. Once the user's identity is established, in one aspect of the present invention, the back office system (110) can regard the financial instructions as originating from the authorized user.

The present invention also contemplates the use of a variety of means of securing information.

For example, the information is encrypted at the communication device (104) by operation of an encryption utility (not shown) linked to the communication device (104), thereby ensuring encryption of data between the communication device (104) and the back office system (110) via the communication network (106).

In a particular aspect of the present invention, digital pen requests are encrypted in a manner that is known to reduce the livelihood of unauthorized monitoring and reading of the financial instruction traffic based on the markings captured by the digital pen (102), but also to ensure that a digital pen request is not tampered with. In one particular embodiment of the present invention, the information transmitted between the digital pen (102) and the financial institution (or the processing company, if the service is outsourced) may be encrypted using a 128-bit (or different encryption strength) symmetric and unique key shared between the digital pen (102) and the financial institution. As a particular example of security enablement of the present invention, digital pen (102) may be operable to generate a 128-bit symmetric session key to encrypt the information that is sent to the financial institution. This key may be attached to the data sent and enable the financial institution to decrypt the information. To ensure that only the financial institution can read the information related to the financial transaction, the digital pen (102) may encrypt the transmitted key. The encryption of the digital pen's session key may be based, for example, on a standard 1024-bit RSA asymmetric encryption, which is a common asymmetric algorithm. Asymmetric encryption is designed so that the key used for encryption (the public key) is different from the one used for decryption (the private key). Thus, to encrypt digital pen requests between the digital pen (102) and the financial institution in an open service, an asymmetric key pair may be required. When the user marks the “SEND” box on the digital (101) (as explained below), the API (108) of the present invention may be operable to send the public key to the digital pen (102) and then the digital pen (102) thereafter may use the public key as a session key for encrypting information that is sent to the financial institution.

The present invention contemplates the use of a variety of encryption technologies, including for example symmetric key encryption, or Public Key Infrastructure (PKI) enablement of the technology of the present invention. These technologies may be associated with one or more of the devices that are part of, or linked to, the system of the present invention.

The association of a unique identifier with each digital pen (102) may enable the financial institution to maintain an accurate, time-stamped audit trail and also allows important customer relationship information to be derived.

In view of the feedback for example between the communication device (104) and the back office system (110), or between the communication device and various communication systems linked to the back office system (110) that allow personnel of the financial institution to communicate in order to provide support, or cross-sell products or services, to the end user, various communications may occur between the end user and the financial institution as part of a single financial transaction. It is desirable therefore to provide means for authenticating the user such that authentication need not occur for each such various communications. In one particular aspect of an embodiment of the present invention, the back office system (110) may be operable to issue an encrypted ticket once the user has been identified, which encrypted ticket is then associated with subsequent communications related to a particular transaction or interaction between the user and the back office system (110), depending on the security protocols defined by the back office system (110). In one particular aspect of this embodiment of the invention, the security ticket is attached by the digital pen (102) to subsequent communications (e.g. transaction request(s)) by operation of an API associated with the digital pen (102) (not shown).

The validity of the ticket can be limited to a certain period of time, ten minutes, for instance. In such case the financial institution may decide, that the API of the digital pen (102) will not accept any pen requests with a ticket that is older than the specified time limit. Such stringent security measures may be well justified for example for transfers of large amounts. These conditions are usually communicated with customers via the terms and conditions associated with use of the applicable accounts.

A technology for capturing digital signatures and “sealing” a document (e.g. a digital form (101)) for authentication purposes such as that marketed by TRODAT™ can be used.

### REPRESENTATIVE EMBODIMENT OF THE INVENTION

The description below illustrates the present invention in connection with examples of the application, in particular two specific examples of the implementation of the present invention, namely in relation to a paper based form (100) that provides (1) a “digital cheque” or “E-Cheque”, and (2) means for processing a wire transfer request in accordance with the present invention, namely a “E-Wire Transfer” or “digital payment transfer/wire transfer form”. The present invention contemplates the use of various other paper forms and related transactions, some of which are referred to in the description, and other that would be obvious to those skilled in the art.

The digital pen (102) may be linked to a character recognition program, whether associated with the communication device (102) or a computer in addition to the communication device. Examples of suitable character recognition program such as MYSCRIPT™ from VISIONOBJECTS™.

Information written on the digital payment transfer/wire transfer form (see FIG. 7) (100) or the digital cheque (see FIG. 8) with the digital pen (102), is digitized, optionally encrypted and stored, and thereby made ready for transmission via the communication device (104). For example, the data may be stored on the digital pen (102) itself. Different makes of digital pens (102) may have different data storage capacity. The current newer generation of pens can hold a total of about 200 forms. There can be different types of connections to the communication device (104), for example: (i) BLUETOOTH™; or (ii) universal serial bus (USB).

It should be understood that “communication device” (104) in this disclosure means any type of electronic device that is capable of supporting (two way) data transmission via wireless Internet, Global System for Mobile communication (GSM), or code division multiple access (CDMA) telephony or any other type of communication technology, as well as a BLUETOOTH™ enabled or USB connection to the digital pen (102) such as a BLUETOOTH™ or USB equipped cellular telephone (120), PDA, notebook, laptop (118), PC, etc. The communication device (104) is generally connected to a cellular network (106) or other associated network. This type of network is generally available and generally provides greater operational stability than Internet networks available to prior art on-line lap top based solutions. Furthermore, the communication device (104) consisting of a wireless communication device such as a mobile phone or PDA is generally less costly, more portable, and operationally more robust than a laptop, as shown in FIG. 3A and FIG. 3B respectively. Accordingly, the invention described herein is more versatile and less costly than the system of printers disclosed in U.S. publication 2004/0083174 A1.

The communication device (104) may nonetheless consist of a portable laptop (118) that is connected to the digital pen (102) for processing the digital (paper) forms (100),(101) of the present invention, as illustrated in FIG. 3B. The laptop (118) may be used particularly in areas where its functionality is desired, for example, to access the bank's back office system (110) on-line to view and print transaction history, bank account statements, etc. It is possible that the communication device (104) may consist of a cellular phone and in addition a laptop for such purposes, as illustrated in FIG. 3C. In this case the paper forms (100) of the present invention, operating as described herein, with the digital pen (102) and the communication device (104) may provide a backup where Internet connectivity cannot be readily provided to the laptop (118)/personal computer.

The digital payment transfer/wire transfer form (see FIG. 7) or digital cheque (see FIG. 8) (100) generally includes at least one “SEND” field marking the end of the paper form (100), or a section of the paper form (100). Marking the “SEND” field triggers the execution of a generic processing routine (e.g. provided as part of the ANOTO™ functionality) or of a proprietary program linked either to the digital pen (102) or the communication device (104) or both. The “SEND” field consists of an area that is defined on the digital cheque (see FIG. 8) or digital payment transfer/wire transfer form (see FIG. 7) (101) which when activated or marked using the digital pen (102) initiates a process whereby some or all digitized information is transferred to the back office system (110) for further processing, as part of a particular process defined based on business rules associated with the back office system (110). This process may be coded in the communication from the communication device (104) using an identification tag that, for example, identifies a specific rule or process. In line with the concept of a thin client solution, the communication device (104) may perform functions such as data encryption/decryption, some degree of data editing/validation, providing time stamps to data strings transmitted, etc., in order to reduce communication costs and increase speed of processing. Other similar command areas may be incorporated into a paper form (100) in accordance with the present invention.

In addition, the digital payment transfer/wire transfer form (see FIG. 7) or the digital cheque (see FIG. 8) may possess an additional “NEGOTIABLE” field. This field would be operable to assist in distinguishing whether or not the digital payment transfer/wire transfer form (see FIG. 7) or the digital cheque (see FIG. 8) should be operable in a digital or non-digital fashion, especially if the communication network (106) is not functioning and the relevant paper form (100) will be used as a traditional paper instrument. In one aspect of the present invention, a “NEGOTIABLE” field on a paper form (100) (such as a wire transfer form or digital cheque) may be operable to ensure that the paper form (100) will not be processed by the back office system (110) in the manner described above. In one particular implementation, a code is associated with the “NEGOTIABLE” field that is operable to ensure that information related to the particular paper form (100) where the “NEGOTIABLE” field has been marked is not sent to the back office system (110) on-line Obviously, in this particular implementation, the “NEGOTIABLE” field is marked prior to marking the “SEND” field, or the “SEND” field is not marked at all. Marking the “NEGOTIABLE” field could either disable the “SEND” field or if transmission of data is allowed, the system would classify such request as ‘informational only’, i.e. not to be processed by the back office system. Also an appropriate message may be sent to the communication device of the customer.

A routing means such as routing software loaded on the communication device (104) may enable transmission of data to a predefined server address or predefined multiple server addresses for further processing in a manner that is known.

The back office system (110) may constitute multiple related systems, each system possibly including an application repository (124) for hosting various applications involved in processing, recording, and analyzing financial transactions, including but not limited to processing payments. This is certainly the case with typical banking environments as an example. In one aspect of the present invention, digital payment transfer/wire transfer form (see FIG. 7) or the digital cheque (see FIG. 8) and the communication device (104) are integrated with the functions of the back office system (110), and the various processes that are embodied in the back office systems (110) including the application repository (124), access to which is provided via the server (112) through the server application (122). This is achieved by ensuring that the digital payment transfer/wire transfer forms (see FIG. 7) or the digital cheque (see FIG. 8) are consistent with back office processes, and also that incoming data from the digital payment transfer/wire transfer forms (see FIG. 7) or the digital cheque (see FIG. 8) is tagged and/or translated to a corresponding digital form (101) that enables relevant data elements to be included in the workflow of the back office systems (110) on a seamless basis.

To this end, in one particular aspect, the system of the present invention includes a customizable Application Program Interface (“API”) (108) which provides an interface between the various communication devices (104) and the back office system (110). The API (108) is operable to decrypt data received from the communication device (104) (if the data is encrypted), tag the data as required in accordance with the back office system (110) processes, translate the data into one or more formats if required by the back office system (110) processes, interface with the application repository (124) that is part of the back office system (110), and place data elements into the back office system (110) workflow. The API (108) may be linked to a database (114) including a rules repository (116) that determines the specific rules for processing specific data (based on a field from a particular form, or particular data provided by a customer that might trigger a security alarm, initiates customer identity/history related checks, payment transactions and the like.), in accordance with predetermined back office processes. The API (108) may also constitute as an Electronic Data Interchange (EDI).

In a particular aspect of the present invention, the API (108) includes a generic set of API's to retrieve the data and use them in various silos of applications (124) in the back office system (110) environment.

As depicted in FIG. 1., in accordance with another particular aspect of the present invention, the back office system (110) may include a server (112), whether hosted by the financial institution or an outsourced entity, which hosts the data from which data extraction takes place. The API (108) may include a data extraction module (130), for example, one based on the Electronic Data Interchange Service (“EDI”). The data extraction module (130) may provide a mechanism for sending data to and/or retrieving data as part of the solution. EDI allows the transfer of structured and coded data, by agreed message standards, from computer to computer, by electronic means.

The API is linked to a database (114) that maintains the various types of form templates. Using this information, the data extraction module (130) may extract/interpret the relevant data from the file(s) captured/transmitted by the digital pen.

The data extraction module (130) may be operable to generate files that may be used by the back office system (110) for application integration purposes, by enabling file generation in accordance with specific file formats required by the back office system (110) or specific applications that are part of that environment. For example, the data extraction module (130) may be operable to generate XML files based on data collected as part of the digital payment transfer/wire transfer form (see FIG. 7) or the digital cheque (see FIG. 8) (100). The solution may provide functionality for generating a file (e.g., XML) by default. Since the file generation is modularized, more sub-modules may be added to generate files in various formats for specific cases.

The data extraction module (130) may be operable to create a structured file that corresponds to the electronic information embodied in the transaction forms, for instance in the digital payment transfer/wire transfer form (see FIG. 7) or digital cheque (see FIG. 8) or (100) used by the financial institution.

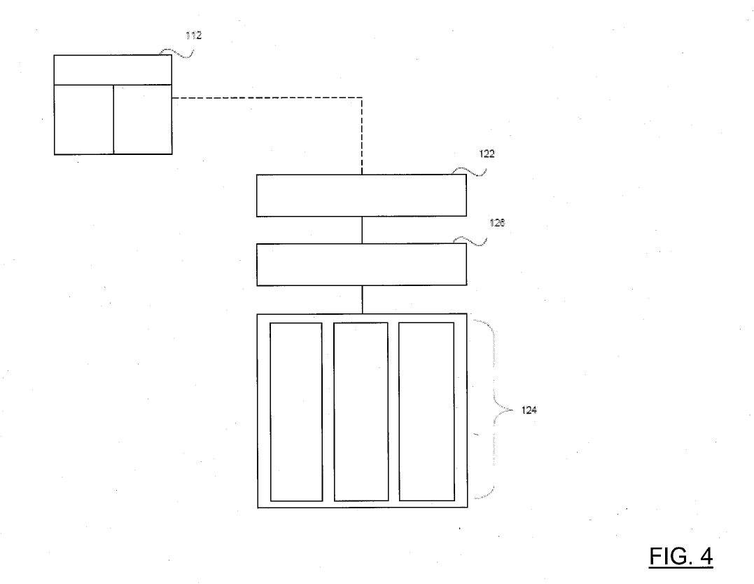

In one particular aspect of the present invention, as illustrated in FIG. 4, the back office system (110) may include a listener/sender program (126) that is operable to monitor pre-defined ports in order to integrate data from the API (108) into the workflow of the back office system (110). As soon as a file is generated by operation of the API (108), the listener/sender program (126) may read the file as a stream and process the data using its existing applications. Minor modifications may be required at the application level to receive the data in the file from the API (108) instead of, for instance, the manually entered data. The response after the data processing is completed may be sent back to the same port as another file. A messaging utility (128) linked to the API (108) as shown in FIG. 1 (but that may instead be linked to the back office system (110), depending on the particular implementation) may be operable to send information back to the communication device (104) in accordance with the transaction processing rules. The message may include the feedback described above, and may be provided in the form of a text message to the communication device (104).

In accordance with specific implementations of the present invention, translation of the data may be handled by the back office system (110) rather than the API (108), i.e. the API (108) of the present invention may act more as a standard API merely to provide a communication interface between the various digital pen (102)/communication devices (104), configured in accordance with the present invention, and the back office system (110). The API (108) may also be operable to act as a hosting server for one or more applications operable to address a plurality of customer scenarios. For example, the API (108) may be operable to authenticate, validate and analyze data in accordance with a series of processing templates provided to the rules repository (116) prior to presenting the data to the back office systems (110). In particular, the processing templates are based on the transaction forms, such as the digital cheque or digital payment transfer/wire transfer form (100) and are stored in the rules repository (116) of the database (114) linked to the API (108), which in turn is linked to the back office system (110).

The present invention also contemplates various tools to parse data and feed the data to applications linked to the back office system (110), resolve errors, etc., whether as part of the API (108) or part of the back office system (110).

The present invention enables the financial institution to continue to use cheques/wire transfer forms (with possible minor modifications) that they and their customers are familiar with, yet as part of a system where data is digitized, and therefore valuable information and feedback may be interactively obtained and provided by operation of the back office system (110) in real-time or near real-time. As stated above, transaction forms, like the digital cheque or digital payment transfer/wire transfer forms (100) described, integrated with the API (108) and the back office system (110), enables a fully integrated on-line processing whereby account holders of the financial institution may generate electronically financial instructions, including payment instructions, for execution by the financial institution in real-time or virtually in real-time. This generation of electronic financial instructions depends on network connectivity that may be more reliable and secure than the Internet, for instance. The use of the paper forms (100) may enable collection of signatures for authentication and non-repudiation. The digital cheque or digital payment transfer/wire transfer form (100), upon approval (e.g. upon issuance of a payment processing ID), can be kept as a backup/safety copy document for the actual outgoing payment transaction to be left with the customer, as the relevant data that may be required by the financial institution from the digital cheque or digital payment transfer/wire transfer form may have already been captured electronically. This may eliminate the steps and associated costs of sending the cheque or payment transfer/wire transfer forms through other means for further processing by the financial institution. All of these advantages are provided in a cost effective manner, given that the acquisition costs for the technology components described are relatively small.

The use of digital cheques, as per the current invention, may result in some changes to the concept of cheque usage. Presenting the traditional cheque by the payee at his/her bank branch is currently critical, since it may be the only way to identify the payee in accordance with traditional cheques, without which the cheque based payment transaction can not be completed. Without presenting the cheque for instance by Mr. John Smith as a payee, his financial institution may not be aware that someone has the intention to make payment to him, nor may the financial institution be able to determine who he is, if there was more than one customer with the name of Mr. John Smith at a financial institution. Presenting the cheque to a bank branch may serve as the means to identify him among the customers of the financial institution, triggering a process of collecting the funds stated on the payer's cheque on behalf of the payee from the payer's financial institution.

The process becomes significantly faster and simpler in the case of digital cheques, since the payee provides the bank information, which is necessary to complete the payment, to the payer. Such process/transaction can typically be completed relatively quickly (depending on the resources of the financial institution, and the financial institution's protocols) and requires no action by the payee, since the transfer funds will be wired directly into his/her account by the payer's financial institution.

Providing the payee with the digital paper based cheque serves no practical purpose, therefore customer's of the financial institution may be advised against it. In case a financial institution and/or the payee still wants a hard copy to be provided to the payees, a so called carbon copy may be considered that could be marked as a “Not for processing copy” of the original.

The use of the present invention for e-wire transfers utilizes the sensing device or digital pen (102). Completion of the paper form (100) itself may be almost identical to the traditional wire transfer form, except as described above. Once data is transmitted to financial institution for further processing, the payer & the payee may have no other activity to perform. Depending on the financial institution, the payer might receive a payment confirmation identifier, as described above. Again, depending on the financial institution, the same message can be sent to the payee as well, provided that the appropriate fields on the digital wire transfer form are filled out.

An additional advantage of the present invention is the maintenance of a paper audit trail, and it also serves as a backup solution to failures of a technical nature. Significant benefits may be realized by the use of the present invention by capturing, digitizing the customer's signature with biometric accuracy and transmitting it along with data also captured on the digital cheque or digital payment transfer/wire transfer form to the office and perform real-time data validation, since errors related to a form's completion are most efficiently corrected at inception rather than via lengthy follow-up procedures that might even require at least another contact to be made with the account holder or the authorized signatory. Depending on infrastructural conditions, the present invention creates the opportunity to initiate the execution of payment transactions real-time or near real-time.

The present invention contemplates analysis of the business processes of the financial institution and user requirements in order to arrive at specific paper form (100) designs, such as that of a digital cheque or digital wire transfer form, including in order to adapt forms in use to the new process facilitated by the present invention that is based on interactive, two-way communication between an account holder/signatory and the financial institution, allowing essentially real-time generation/execution of outgoing payment transactions, for instance.

### EXAMPLES IN OPERATION

### Processing of Digital Cheques and Digital Wire Transfers

The present invention is further explained by reference to specific operations based on specific outgoing payment instruction forms, such as digital cheques and wire transfers or payment orders.

In the current examples, the digital cheque and the digital wire transfer or payment order forms (100) contain all data fields that are required by the given financial institution in order to be able to authenticate and execute outgoing payment instructions. The digital wire transfer form (FIG. 7) or digital cheque (FIG. 8) generally include a “SEND” field as described above. Once the form is completed, activating or marking the “SEND” field using the digital pen (102) triggers the transmission of data written onto the form (and simultaneously digitized by the digital pen (102)) to the connected communication device (104), such as for example a GSM™ telephone. Information written onto the form is captured and transmitted to the predefined e-mail, SMS or MMS or other type of server addresses for further processing.

The system of the present invention facilitates various data transmission formats to be used, like MMS, which allows sending a single message to multiple recipients. This MMS capability may enable the creation of a high security redundant information relay infrastructure. Beside MMS, there are other data transmission alternatives also, known to those skilled in the art.

The design of cheques is relatively well standardized, as demonstrated in FIG. 5 by the example of a traditional cheque. The payee related information on the traditional cheques is incomplete; therefore the processing of such payment instrument requires the cheque to be physically presented to the bank/branch of the payee in order to perform the customer (payee) identification so processing of the payment transaction may commence. Presenting the “physical” cheque is what other electronic payment methods, such as wire transfers solve by requiring full and ‘bankable’ information to be provided on the payee: name of the beneficiary, the financial institution and the bank account number.

It should be understood that certain features of the design of paper forms (100) may be standardized by a single financial institution, by several financial institutions by means of co-operation between them, or by regulation. As demonstrated in FIG. 6, by way of example, a traditional wire transfer form that is typically filled out at the branch of the account holder and handed over to the bank teller for further processing. After identifying the customer, the teller may key in the payment information from the form presented and performs the initial part of processing the payment instruction, that may include some data validation and checking of available balance in order to determine if the payment instruction can be processed. If everything is found in order, the teller may stamp the payment order form and hand a copy over to the customer. Such outgoing payment instructions typically (but not necessarily) are processed over night by the back office system (110).

As demonstrated by the example of a digital wire transfer form in FIG. 7, the digital wire transfer form may be identical to the traditional wire transfer form (see FIG. 6) in terms of information content, since wire transfer forms identify the payee in a ‘bankable’ manner, unlike traditional cheques (see FIG. 5), where the payee is not sufficiently identified in order to execute any payment instruction and therefore, as explained above, the payee has to take the cheque to his/her bank branch to complete the customer identification process.

However, beside the ‘traditional’ content, a digital wire transfer form in accordance with the present invention may also includes optionally five additional fields:

### 1. “Irrevocable, Certified Payment”

to specify that the payment to be made is certified, it is irrevocable and the transfer amount has essentially been put on hold, the payment transaction specified in the particular payment instruction is ready for execution. Such type of payment instruction can not be cancelled once approved by the financial institution.

### 2. “Negotiable Payment”

to specify that the current payment instruction is negotiable, meaning it can be cancelled by the bank account holder and/or even possibly by the authorized account signatory (depending on the internal processes of the given bank) and also it might not be executed due to higher priority withdrawal(s) causing a potential ‘Insufficient Funds’ conditions to occur.
   3. “Additional Payment Confirmations Sent to”
to request payment confirmation messages to be sent to additional addresses (e-mail and/or cellular phone numbers), as per the current example. Depending on the decision by the bank and/or the contract between the bank and the bank account holder regulating the use of the bank account, payment confirmation messages may be sent to the default address(es) of the bank account holder. However, for instance, the customer might want or might be required to send a copy of the payment confirmation message to the address(es) of the payee or elsewhere as well.

### 4. “Reference Number

allowing the bank account holder or the authorized account signatory to specify a so called reference number corresponding to his/her chart of accounts, enabling the bank to provide a bank account statement sorted into categories as per the customer's chart of accounts (for instance ‘Utility, Gasoline, Car Insurance, Salary, Materials, Sales Tax, Unemployment Insurance, etc).

### 5. “Recurring Payment”

Example 3 above contains an entry that allows the definition of recurring payments. Recurring payments are prescheduled payment instructions to be executed by the financial institution with a certain periodicity, as requested by the account holder (and the signatory authorized to access his/her account).

Using the present invention, digital wire transfer forms (see FIG. 7) may offer the convenience of anywhere and anytime banking, but at the same time, they may also be processed in any of the financial institution branches of the account holder. In a typical case, an account holder or the authorized signatory is using a digital wire transfer form with a unique pattern to be filled out with a pen assigned to the particular customer utilizing a communication device that is also assigned to the customer, in order to ensure high security customer identification.

Once the digital wire transfer form (see FIG. 7) is completed and the “SEND” field is activated or marked, data will be transferred from the customer's digital pen (102) via his/her communication device (104) to the computer system of the financial institution.

Any customer of the financial institution may use the generic digital wire transfer form (with no unique pattern in it) and a digital pen provided by the financial institution in the branch. In such cases the tellers must identify the customer before authorizing the payment transaction initiated by the customer.

Similarly to traditional forms, paper forms (100) in accordance with the present invention may also have ordinary sheets (forms) interleaved with ‘carbon copy’ sheets attached thereto so that additional copy of the payment instruction form may also be produced, for example, to aid the user in record-keeping.

Outgoing digital cheque (see FIG. 8) and/or digital wire transfer (see FIG. 7) (100) based payment instructions may be generated anywhere, including the bank branches of the account holder, in which case the account holder uses the digital pen (102) that may also be provided by the financial institution. When the digital cheque (see FIG. 8) or the digital wire transfer form (see FIG. 7) (100) is completed and the ‘Send’ field is activated or marked, the information on the form that is captured and digitized by the digital pen (102) may be transferred to the computer of the bank for further processing. If there is no communication network (106) available, the digital pen (102) may store the data and resend the payment instruction to the financial institution which can be subsequently attempted when network coverage is restored.

In order to make digital cheques (see FIG. 8) substantially ‘instantly processable’ all information to be able to identify the payee, his/her bank and bank account, has to be provided, as shown by the digital cheque example in FIG. 8.

The digital cheque shown in FIG. 8, resembles traditional cheques (see FIG. 5), except for the additional bank information (the name of the Beneficiary's bank and bank account number) that is typically not available on cheques and the SEND field(s). As opposed to the traditional cheques evidenced by the example in FIG. 5, digital cheques (see FIG. 8), as part of the current invention, containing the name of the beneficiary's bank and bank account number.

The digital cheque, as part of the current invention, optionally may contain four additional fields:

### 1. ‘Irrevocable, Certified Payment’

to specify that the payment to be made is certified, it is irrevocable and the transfer amount has essentially been put on hold, the payment transaction specified in the particular payment instruction is irrevocable and is ready for execution.

### 2. ‘Negotiable Payment’

to specify that the current payment instruction is negotiable, meaning it can be cancelled by the bank account holder and/or even possible by the authorized account signatory (depending on the internal regulation of the given bank) and might not be executed due to higher priority withdrawal(s) causing a potential ‘Insufficient Funds’ condition to occur.
   3. ‘Additional Payment Confirmations Sent to’
to request payment confirmation messages to be sent to three additional addresses (e-mail and/or cellular phone numbers), as per the current example. Depending on the decision by the bank and/or the contract between the bank and the bank account holder regulating the use of the bank account, payment confirmation messages can be sent to the default address(es) of the bank account holder. However, for instance, the customer might want or might be required to send a copy of the payment confirmation message to the address(es) of the payee, or elsewhere as well.

### 4. ‘Reference’

allowing the account holder or the authorized account signatory to specify a so called reference number corresponding his/her chart of accounts, enabling the bank to provide a bank account statement sorted into categories as per the customer's chart of accounts (for instance Utility, Gasoline, Car Insurance, Salary, Materials, Sales Tax, Unemployment Insurance and the like).

Various other features may be included in the paper forms (100) without departing from the present invention. For example, a balance inquiry may be included in the digital cheque to aid the user in deciding whether the upcoming transaction amount of a digital cheque is appropriate relative to funds available, on account. The balance inquiry feature may be readily implemented as a field in the digital cheque form, and may be associated with a “SEND” field. In response to activating or marking the “SEND” field, a message is sent to the back office system (1220) requesting balance information. Marking the “SEND” field, triggers the digital pen (102) connected to the customer's communication device (104) via Bluetooth connection or otherwise, to issue a balance information request to the financial institution. Customer identification occurs, as explained above. If customer identification is not confirmed, the financial institution may contact the customer directly, for example by telephone, for identification purposes, before releasing the account balance information.

As mentioned earlier, since it is possible to prepare each digital cheque with a unique form-ID, the financial institution may know precisely what particular digital cheque (see FIG. 8) belongs to which particular bank account holder. In agreement with bank account holders, payments may be stopped if ‘alien’ cheques are used. Also as explained above, each digital pen (102) is uniquely differentiated with an ID, that is part of each data transmission, therefore the financial institution may know that a particular cheque has been filled out with a digital pen (102) not assigned to a particular set of digital cheques ((see FIG. 8) (i.e. does not belong to a particular account holder). In such cases, as a precautionary measure, the financial institution might opt for contacting the account holder for requesting confirmation on the legitimacy of the payment transaction in progress. The same might apply if the cellular telephone set (120) used for transmitting data from the digital pen (102) is not assigned to the particular customer.

For ease of identification, back office systems (110) typically assign a unique Customer-ID and/or bank account number to their customers (bank account holders and authorized signatories), since they do not have unique names. In case of cheques, customers may be identified by their name that may be pre-printed on the top left corner; their account number is pre-printed on the bottom left corner as a result, and therefore traditional cheques (see FIG. 5) can be more readily copied/falsified.

The use of the present invention may allow each cheque to be overlaid with a unique pattern and a specific pattern range may be linked to a specific customer making fraud due to illegitimate replication of customer's cheques relatively improbable. In a particular implementation of the present invention, each data transmission from the communication device (104) to the back office system (110) may include the cheque pattern-ID and also the ID of the digital pen (102) that was used to fill out the cheque and perform the data transmission. Financial institutions may not only register and keep their customers' pen-ID on file for verifying each data transmission, but also, each unique cheque pattern, after being used, may be flagged and be removed from the list of available patterns.

Furthermore, in one particular implementation of the present invention, signatures may be captured with biometric accuracy. Handwritten signatures may be captured biometrically using a number of known methodologies. For example, the biometric signature may be stored and used in subsequent transactions for purposes of non-repudiation. It should be understood that the security features that may be readily included in an implementation of the present invention, as described above, may reduce fraud, particularly as it relates to false cheques, which is a significant problem.

Additionally, it is important to consider that communication networks (GSM, CDMA, etc.) utilized to transmit the data may be far more secure than virus plagued Internet networks that are customarily used with other electronic payment systems offered to customers of financial institutions. Moreover the present invention may reduce the impact of Internet “phishing” and other similar deceptive techniques which have a significant impact on financial institutions and their customers. “Phishing” consists of sending an email to a customer of a financial institution that is designed to appear to originate from the financial institution, but in fact originates from a rogue organization. The customer may be invited to provide log in or account information, which is harvested by the rogue organization. This information can then be used to gain illegal access to accounts for financial gain.

In a further embodiment of the present invention, if the customer requests a transaction using digital cheque (see FIG. 8) but does not have enough funds in the principal account or the overdraft account, the financial institution may consider extending to the customer a loan or a line of credit based on the customer's banking history and customer's ranking with the financial institution. This offer and acceptance could also be conducted in real-time or near real-time by operation of messages to the communication device (104) for example, or a courtesy call by a representative of the financial institution to the customer, in real-time or near real-time manner.

In a further embodiment of the present invention, the digital cheque (see FIG. 8) or wire transfer form (see FIG. 7) (100) may allow for further customization that would permit the customer to indicate in what manner s/he would like to receive transaction confirmation by the financial institution especially if this manner is different from the current mode of practice.

In addition, a further embodiment of the present invention may permit the digital cheque (see FIG. 8)/wire transfer form (see FIG. 7) (100) to provide for a reference code. The reference code could be used by the customer to indicate a file number, matter number or a simple reference number that will allow the financial institution to filter, group or sort the payment transactions on monthly statements produced for the account holders. In addition, this monthly statement may be provided to the customer in a parseable format such as XML, or a spreadsheet format etc. The reference number may be captured and attributed to a transaction, with no significant additional cost to the financial institution. This could be of tremendous assistance and convenience to customers, however, reducing the time involved in processing of expense reports, for example, or billing of disbursements incurred on behalf of customers.

In a further embodiment of the present invention, to overcome the reluctance of some individual(s)/business(es) from providing essential banking information such as bank account numbers, the invention may permit for a unique identifier (such as an e-mail address) to be utilized. The customer may complete the digital cheque (see FIG. 8)/wire transfer form (see FIG. 7) (100) in the usual format but instead of including a bank account number, the customer may include the payee's desired identifier (i.e. e-mail address) and financial institution. In turn this e-mail address may be linked/defaulted to a specific account. If the e-mail address specified on the particular payment instruction is not specifically linked to an account, the payer will be notified of the situation via a message to their communication device (104) or the financial institution may contact the payer by other means, for example by sending an email requesting the particulars of the account to be credited with the amount from the payer.

In a further embodiment of the present invention, the financial institution may permit for the creation of a bill payment form (100) that may include the desired utilities or services of the customer and would subsequently permit the customer to submit payments to these utilities or services to be received by the financial institution. This may be achieved in a similar manner to an on-line banking bill payment system.

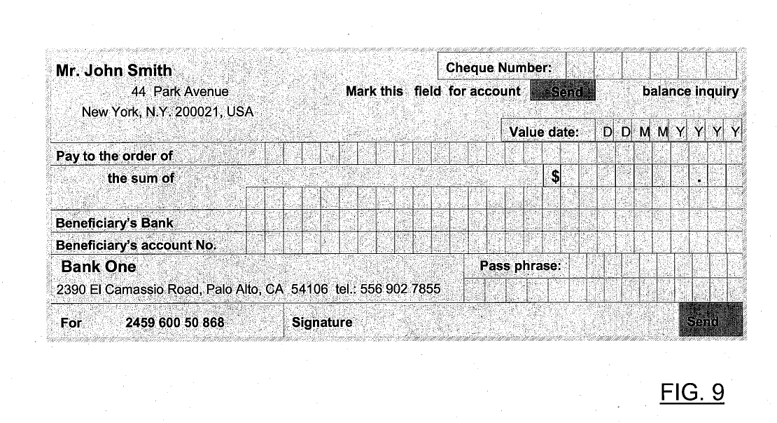

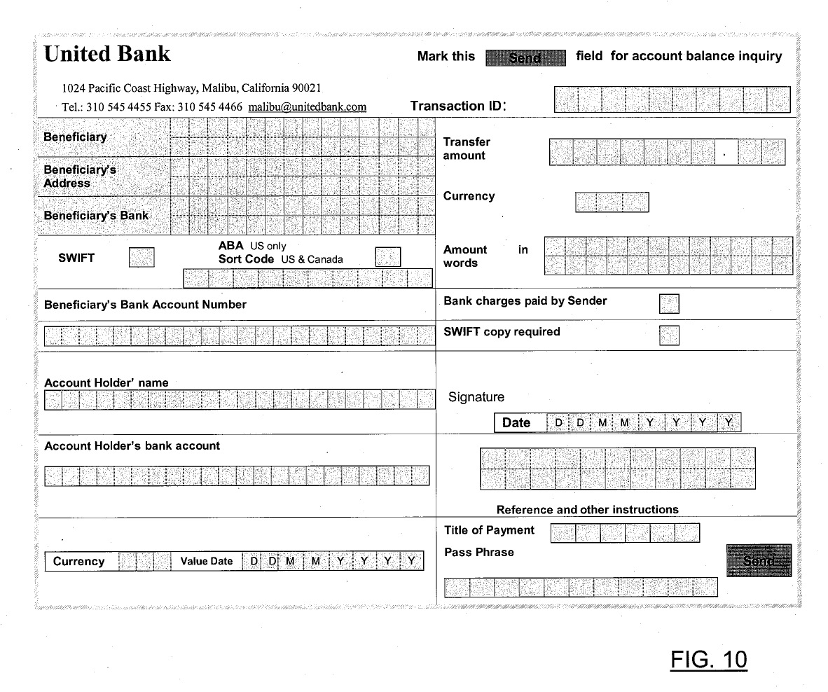

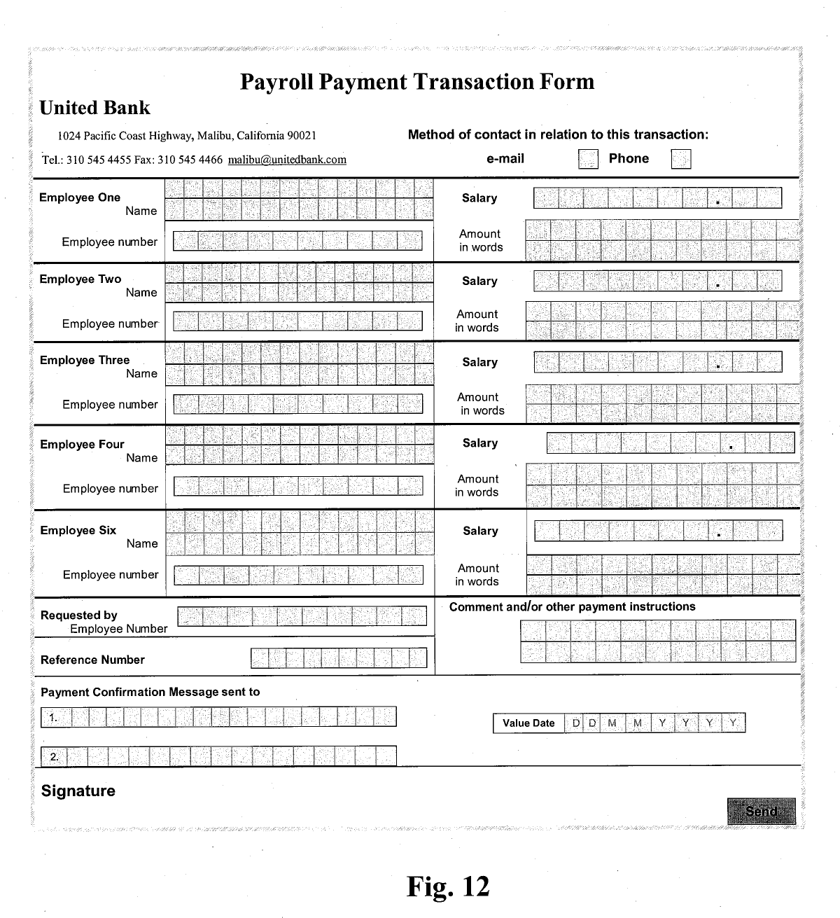

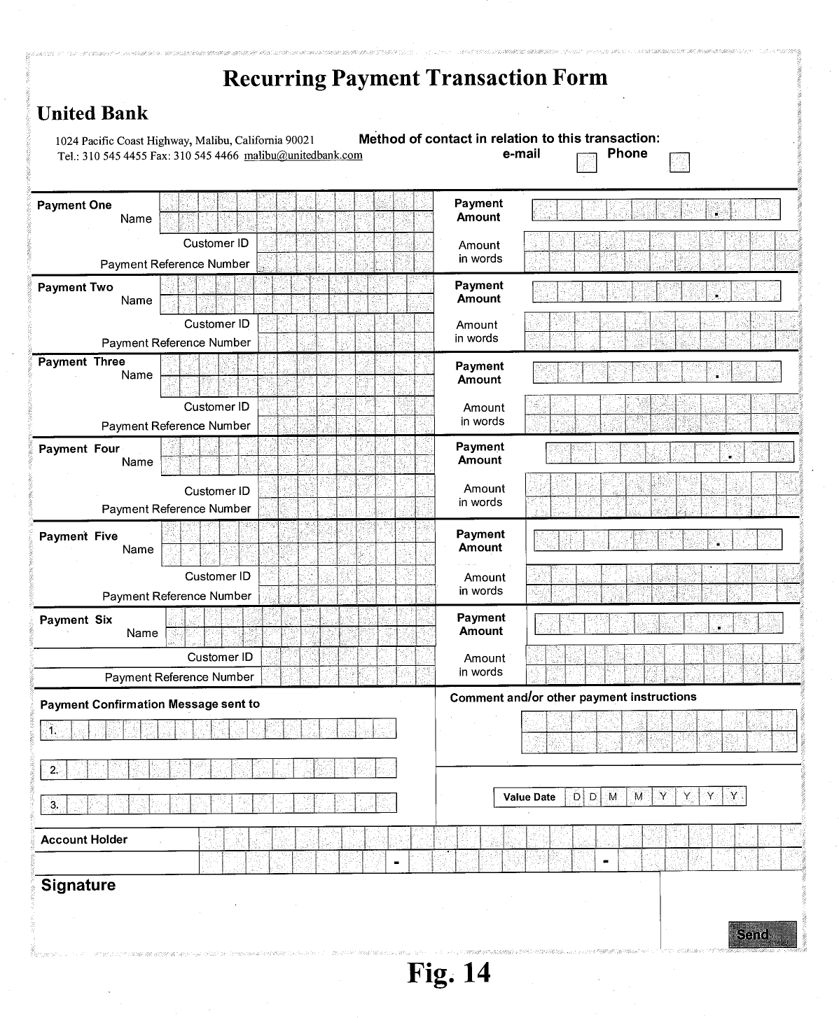

It should be noted that cheques and wire transfer forms as described above may be disposable transaction medium, since they may only be used for conducting a single transaction. In another embodiment, as per FIG. 9 and FIG. 10 of the present invention—both the digital cheque (FIG. 9 and the digital wire transfer form FIG. 10), as well as the Payroll Payment and the Recurring Payment Transaction Forms, FIGS. 12 and 14 respectively, may be produced as a template made out of plastic with a digital pattern that is unique for each customer allowing multiple (unlimited) use of the transaction medium. In this embodiment of the present invention it is not possible to provide a unique digital pattern to each outgoing payment transaction (or balance inquiry) generated. However in addition to tagging each data transmission with a unique time stamp, in both cases of the digital cheque template and the digital wire transfer template, the customer may have the option of providing his/her a “Cheque Number” (see FIG. 9) or a “Transaction ID” (see FIG. 10). Many financial institution customers number their traditional cheques for potential subsequent reference and identification. The template based embodiment of the present invention may in principle be considered identical to bankcards, widely used by the banking industry today since those—unlike for instance traditional cash withdrawal forms or cheques may be reused to perform banking transactions any number of times. Due to the reusability of the digital cheque (see FIG. 9) or wire transfer form (see FIG. 10) (100) templates, in this embodiment of the invention, there would be obviously no paper audit trail for the transaction available other than for example the bank account statement subsequently provided by the financial institution, and any other record or log kept by the financial institution for the purpose of recording the relevant financial transactions.

After completing the digital cheque (see FIG. 9) or wire transfer form (see FIG. 10) (100) template, marking the “SEND” field and transferring the data captured into the digital pen (102), information written onto the template may be wiped off, making the template ready for performing the next transaction. Information written onto this medium and simultaneously captured by operation of the digital pen (102) may not necessarily have to be visible to the human eye. Or if it is, an ink is used in the digital pen (102) that is readily wiped from the plastic surface of the digital payment template. Therefore showing the data written onto the template on the display monitor of the communication device (104) of the user prior to transmission of information to the back office system (110) in this implementation may be advisable.

It may be desirable in other circumstances as well to provide for a utility on the communication device (104) that is operable to display the information as captured in accordance with the invention, prior to transmission to the back office system (110), for example in order to confirm information or correct any errors. One of the advantages of the present invention is that any error may be brought to the user's notice in a communication back from the back office system (110), i.e. corrections (if required at all) need not be made prior to transmission. However, some users may want to confirm that all of the information has been captured correctly prior to transmission. To this effect, the display (not shown) on the communication device (104) may display the fields of the applicable paper form (100), as well as the information provided by the user. The utility may also detect and highlight possible errors and ask for confirmation. It is also possible that the communication device (104) may begin to send one or more transmissions to the back office system (110) for confirmation of identity of payor, financial institution and bank account number of payee, or for whether the user has signed up for certain features of the paper form (100), prior to the actual financial instructions being submitted by operation of the “SEND” button. This way any error or problem may be flagged and remedied as quickly as possible, e.g. via an error message sent by SMS to the communication device (104) or a phone call to the communication device (104) offering assistance. In one particular aspect of the implementation of the invention, the API (108) may be operable to place pending financial transactions into a searchable queue, permitting further changes to instructions, including by operation of an intervention of a representative of a financial institution.

In another particular aspect of the present invention, certain surfaces of the plastic surface may be provided such that the ink of the digital pen (102) does not leave markings. This feature could be useful in protecting passwords or pass phrases to avoid making these viewable by others, even if accidentally. It should be understood that a paper form (100) may be provided with similar areas (for example by coating selected areas of the paper form (100), for example pitch black or of non-marking material, such that markings are not visible). Alternatively, certain areas of the relevant forms may be provided with areas (in a particular colour for example) such that the use r knows to raise the ink portion of the digital pen (102) (relevant in some models) so that electronic information only is generated using the digital pen, and no marking is made.

In a particular implementation of the present invention, the digital forms (101), with the use of so called correction columns on each data entry row on the form, may be operable to permit one or more characters, if incorrect, or incorrectly captured, to be “crossed off” and thereby signalling deletion of the particular information associated with the particular field, and permitting the correct marking to be made over the incorrect information.

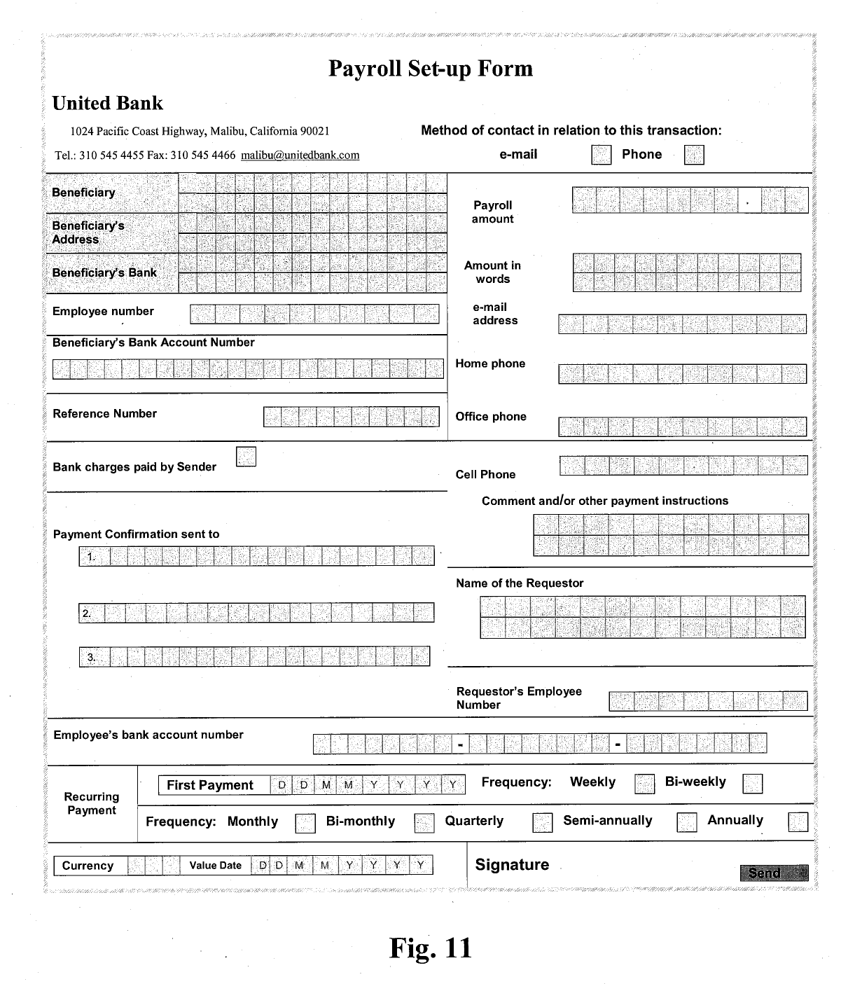

It should be understood that the present invention contemplates the use of various digital transaction forms (101) to embody various financial processes that presently are used as between financial institutions and their customers, as well any financial processes that might be adopted in the future. FIGS. 11-14 discussed below illustrate further examples of paper forms (100), designed for operation in accordance with the method described above. In addition to the digital paper implementation, transaction forms, such as exemplified by FIG. 12 and FIG. 14, may be produced in plastic templates, as explained above, to allow unlimited reusability.

FIG. 11 illustrates as an example of a paper form of the present invention, a payroll set up form. This transaction form (100) provides an efficient means for handling payroll payments, especially for smaller businesses. The Payroll Payment Setup Form illustrated in FIG. 11, in one aspect thereof, contains payee information for the employees, and other information necessary for processing payroll. The transaction form (100), in the current example, contains the Employee Number that can subsequently be used on the Payroll Payment Transaction Form to uniquely identify the beneficiary of the future payroll payment(s).

FIG. 12 illustrates as an example of a digital paper form of the present invention, a payroll payment transaction form. This paper form (100) may enable customers to submit payroll transactions to their financial institution. In the specific paper form (100) illustrated in FIG. 12, up to five employees may be paid at once. Specifying the Reference Number enables related financial transactions previously defined with the financial institution such as a payroll transaction, expense reimbursement (and category therefore). This may enable the financial institution to provide more detailed account statement reporting to the customer. The financial institution, by operation of the back office system (100), may associate various value added services with the payroll processes, such as calculation of source deductions and various payments owed by the employer to government authorities, which can then be communicated or paid automatically, with a tie into the various reporting utilities made accessible to the customers of the financial institution.

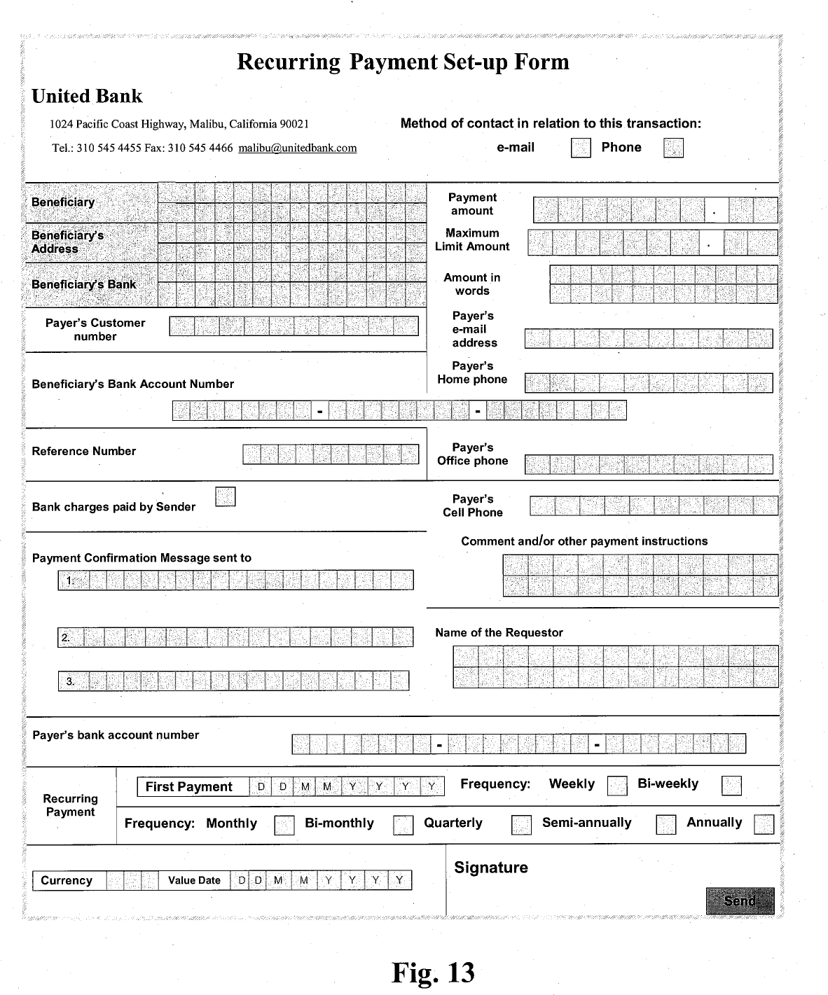

FIG. 13 illustrates as a further example of a paper form of the present invention, a recurring payment set-up form. This paper form (100) may enable a customer of a financial institution to provide the necessary instructions to enable the customer to set up for recurrings for payment certain payees (utility companies and other entities that a customer may need to send payments to on a recurring basis). In some cases, such as utility payments, the exact payment amount may not be specified in advance, but in order to protect the customer from excessive, erroneous billing, a so called “Maximum Limit Amount” can be defined (see FIG. 13). If a particular payment amount is greater that the Maximum Limit Amount, the financial institution will contact the account holder for consultation as to the status of such payment transaction before execution.

FIG. 14 illustrates as a still other example of a paper form of the present invention, a recurring payment transaction form. In one particular implementation of the present invention, a financial institution provides its customers with a “Recurring Payment Set-up Form” for selecting certain payees based on a visit to a branch, sign up through Internet banking, or in fact the additional form shown in FIG. 13 and described above. This particular transaction form (100) generally includes payee information, and therefore may enable the user to fill out the payment amounts. This paper form (100) may also include optionally a Reference Number (such as an account number) to enable the payee or the customer's financial institution to categorize the payments (for example to enable categories of payments, or total amounts paid to particular payees) to be added up more easily and then presented to the customer. This may in turn assist customers in monitoring their spending, and even the preparation of tax returns, for example. Financial institutions may be increasingly interested in providing this type of value added service. The present invention meets this goal in an easy to implement and inexpensive way, that may be very convenient for the customers of the financial institution.

A further aspect of the present invention is that a user may provide its instructions to a financial institution regarding the particular paper forms (100), and possibly certain attributes or features of paper forms (100), which s/he wishes to have on particular paper forms (100). This process is not unlike the way in which bank customers currently order their cheques, with different styles, security features and the like. It should be understood that the various features embodied in the present invention may present revenue opportunities through transaction fees, charges for value-added features, and additional revenue through the improved cross-selling opportunities for financial institutions using the present invention.

The disclosure discusses certain system components, software components, or other utilities, as means for illustrating the operation and implementation of the present invention. It should be understood that the present invention may not be limited to particular software, system, or network architectures or configurations, or to specific allocations of resources or functionality as between particular system components, software components, or other utilities. It should be understood that one or more system components, software components, or other utilities, could be provided as a greater or lesser number of system components, software components, or other utilities. Also, for example, a number of software components described, in particular on the financial institution system side, may be provided as an integrated appliance. A number of software components described (for example in connection with the communication device (104)) could be pre-loaded on the communication device. While add-on utilities have not been discussed, it would be obvious to a person skilled in the art that various add-on utilities can be included into the API (108), for example, to enable maintenance functions, reporting functions, data mapping functions, data translation functions, and enhanced integration features. Similarly, various additional utilities or interfaces may be made part of the communication device (104) or the digital pen (102) to provide enhanced features, building on the invention described. The present invention is not limited to any particular software structure, including any modular structure. The present invention contemplates the use of an ASP model to deliver some or all of the features described, as well as a distributed architecture to provide some of the functionality of the invention.

What is claimed is:

1. A method of enabling on-line processing of instructions by a financial institution comprising:
(a) digitizing handwritten data provided by a user on a medium;
(b) receiving the data at a communications device;
(c) transmitting the data to a server computer associated with the financial institution, the server computer being operable to interpret the data as financial instructions;
(d) the financial institution processing the financial instructions.

2. The method as claimed in claim 1 wherein the generation of electronic financial instructions for electronic processing is conducted in real time.

3. The method as claimed in claim 2 wherein said medium includes a digital pattern.

4. The method as claimed in claim 3 wherein said handwritten data is digitized by operation of sensing device in association with the medium.

5. The method as claimed in claim 4 wherein the financial institution generates feedback made available to the communications device.

6. A method for enabling on-line/real-time generation of electronic financial instructions for electronic processing by a financial institution comprising:
(a) digitizing hand written data provided by a user on a medium, such medium optionally including a digital pattern, by operation of a sensing device;
(b) receiving the data at a communication device;
(c) transmitting the data to a server computer associated with the financial institution, the server computer being operable to interpret the data as financial instructions;
(d) the financial institution processing the financial instructions; and
(e) the financial institution optionally generating feedback, which is made available to the communication device.

7. The method as claimed in claim 6 wherein the medium includes a digital pattern and said sensing device comprises a digital pen.

8. The method of claim 7 wherein the medium is a cheque or any other type of electronic payment transfer form overlaid with the digital pattern that embodies steps of processing payment transaction, and the data is generated by the bank account holder and/or a person signatory to the bank account.

9. The method of claim 6 wherein the data is encrypted when sent by the bank account holder and/or a person signatory to the bank account and decrypted when received.

10. The method of claim 6 wherein the data is processed according to pre-determined criteria set established by the financial institution.

11. The method of claim 6 wherein the data is processed via a comparison with a processing template.

12. The method of claim 6 wherein the feedback is in association with a transaction and includes information, approvals, or a request for further information.

13. The method of claim 6 wherein the data includes a customer signature.

14. The method of claim 6 wherein the feedback enables payment transactions to conclude.

15. A method for enabling on-line, real-time generation of bank payment instructions, the method comprising:
(a) defining a digital format of cheques, electronic payment order or wire transfer forms for processing outgoing payment instructions;
(b) defining a processing template based on the digital cheque, digital payment transfer or wire transfer forms;
(c) receiving data from a bank account holder and/or signatory to the bank account, wherein the data is generated by a digital pen in conjunction with digital cheque, digital payment transfer or digital wire transfer form by the bank account holder and/or the signatory to the bank account and wherein the data is sent by a communication device to a bank; and
(d) comparing the data with the processing template.

16. The method of claim 15 further providing feedback to the bank account holder and/or the signatory to the bank account.

17. The method of claim 16 wherein the data is encrypted when sent by the bank account holder and/or the signatory to the bank account and decrypted when received.

18. The method of claim 17 wherein the feedback is encrypted when sent to the bank account holder and/or the signatory to the bank account and decrypted when received by the bank account holder and/or the signatory to the bank account.

19. The method of claim 17 wherein the feedback is in association with a transaction with the bank account holder and/or the signatory to the bank account and includes information, confirmation message, or a request for further information.

20. The method of claim 17 wherein the data includes the signature of the bank account holder and/or the signatory to the bank account.

21. The method of claim 17 wherein the digital cheque or digital payment transfer/wire transfer form is tailored to the processing standards of outgoing payments.

22. The method of claim 17 wherein the feedback enables an outgoing payment transaction to conclude.

23. A system for enabling the generation of outgoing payment instruction for a signatory to a bank account located remotely from the financial institution, the system comprising:
(a) a digital sensing device operable to generate electronic data when used with a transaction form embodying one or more steps of an associated financial transaction;
(b) a communication device linked to the digital sensing device, for transferring data over a network to back office systems;
wherein the back office systems transmit to the signatory to the bank account feedback regarding the payment request instruction generated.

24. The system of claim 23 wherein the digital sensing device comprises a digital pen.

25. A system for enabling the generation of outgoing payment instruction for a financial institution account holder and/or the signatory to a financial institution account located remotely from a financial institution, the system comprising:
(a) a digital pen operable to generate electronic data when used with a transaction form that embodies one or more steps of an associated financial transaction; and
(b) a communication device linked to the digital pen, the communication device operable to transmit data over a network to back office systems;
wherein the back office systems transmit to the financial institution account holder and/or the signatory to the financial institution account feedback regarding the payment request instruction generated.

26. The system of claim 25 wherein the transaction form comprises data fields for entry of customer information relevant to the transaction.

27. The system of claim 25 wherein the transaction includes one or more SEND fields in association with one or more sections of the data fields.

28. The system of claim 25 wherein the data comprises customer information relevant to the transaction.

29. The system of claim 25 wherein the communication device is a mobile phone.

30. The system of claim 25 wherein the communication device is a personal digital assistant device optionally linked to the mobile phone.

31. The system of claim 25 wherein the communication device is a portable computing device linked to a mobile phone.

32. The system of claim 31 wherein the portable computing device is a tablet or laptop.

33. The system of claim 25 wherein the data is encrypted when transmitted.

34. The system of claim 25 wherein the feedback includes information, approvals, or a request for further information.

35. The system of claim 25 wherein the feedback is generated by processing the data in association with a processing template, the processing template stored in a database.

36. The system of claim 25 wherein the digital pen is linked to a character recognition program.

37. The system of claim 25 wherein the data includes the signature of the bank account holder and/or the signatory to the bank account.

38. The system of claim 25 wherein the transaction form is paper-based and includes signatures for authentication and non-repudiation.

39. The system of claim 25 wherein the transaction form is left with financial institution account holder and/or the signatory to the financial institution account after conclusion of the transaction.

40. The system of claim 25 wherein the feedback enables the transaction to conclude.

41. A system for providing facilities to a bank account holder and/or the signatory to the bank account located remotely from financial institution, the system comprising an application program interface operable to receive data from a communication device, wherein the data is received via a network, wherein the data is generated by a digital pen and digital cheque, digital payment transfer or digital wire transfer form used by the bank account holder and/or the signatory to the bank account in relation to a transaction to generate outgoing payment instruction, wherein the application program interface is linked to office systems by a server, wherein the office systems process the data and provide feedback, and wherein the feedback is provided to the bank account holder and/or the signatory to the bank account.

42. The system of claim 41 wherein the office systems comprise an application repository.

43. The system of claim 42 wherein the application repository comprises a plurality of applications directed at processing, recording and analysing transactional data.

44. The system of claim 43 wherein a listener/sender program integrates dataflow from the application program interface to the application repository.

45. The system of claim 44 wherein the feedback is generated by a messaging utility.

46. The system of claim 45 wherein the messaging utility is linked to the application program interface or the office systems.

47. The system of claim 42 wherein the data comprises information relevant to the transaction.

48. The system of claim 42 wherein the data is decrypted when received from the digital pen and/or the communication device.

49. The system of claim 42 wherein the application program interface includes a data extraction module.

50. The system of claim 49 wherein the data extraction module is an electronic data interchange.

51. The system of claim 42 wherein the feedback includes information, approvals, or a request for further information.

52. The system of claim 42 wherein the feedback is generated by processing the data in association with a processing template, the processing template stored in a database.

53. The system of claim 33 wherein the application program interface is linked to a database, the database including a rules repository.

54. The system of claim 53 wherein the application program interface is operable to authenticate, validate and analyse the data and/or distribute data to one or more back-end systems in accordance with one or more processing templates provided in the rules repository.

55. The system of claim 54 wherein the one or more processing templates are associated with the digital cheque or digital payment transfer/wire transfer form.

56. The system of claim 42 wherein the data includes a customer signature.

57. The system of claim 42 wherein the cheque or digital payment transfer/wire transfer form is digital paper-based and includes signatures for authentication and non-repudiation.

58. The system of claim 42 wherein the feedback enables the transaction to be concluded.

59. A computer program for enabling the generation of on-line financial instructions from a financial institution account holder or the signatory to the financial institution account located remotely from a financial institution, the computer program product for use on a server computer, the computer program comprising:
(a) a computer usable medium; and
(b) computer readable program code recorded or storable in the computer useable medium, the computer readable program code defining a server application on the server computer that is operable on the server computer to establish an application program interface;
wherein the application program interface includes a data extraction module operable to receive data from a communication device over a network, the data generated by a digital pen in connection with a transaction form that embodies one or more steps of an associated financial transaction;
wherein the application program interface is linked to a database, the database including a rules repository, wherein the application program interface is operable to authenticate, validate and analyse the data in accordance with one or more processing templates provided in the rules repository;
wherein the application program interface is linked to office systems, wherein a listener/send program integrates the flow of data from the application program interface to the office systems, the office systems process the data and provide feedback; and
wherein a messaging utility provides the feedback to the bank account holder and/or the signatory to the bank account.
